(19) United States
(12) Patent Application Publication
(10) Pub. No.: US 2012/0046579 A1
(43) Pub. Date: Feb. 23, 2012

(54) MECHANICAL STIMULATION WRAP AND METHOD OF USE

(75) Inventors: Christopher L. Radl, Malvern, PA (US); Robert Kropp, Norristown, PA (US); Allison Lloyd, Spring City, PA (US); Pat Paul, Norristown, PA (US)

(73) Assignee: BOEHRINGER LABORATORIES LLC, Phoenixville, PA (US)

(21) Appl. No.: 13/210,733

(22) Filed: Aug. 16, 2011

Related U.S. Application Data
(60) Provisional application No. 61/374,812, filed on Aug. 18, 2010.

(51) Int. Cl. A61H 1/00

(52) U.S. Cl. 601/46

(57) ABSTRACT

A system and method of use for providing vibratory energy to a portion, e.g., the leg, of a living being for producing a beneficial effect, e.g., relief of RLS symptoms, is disclosed. The system is in the form of an elastic wrap or band arranged to be releasably secured to the portion of the being and holds plural electrical motors, which when operated vibrate. The vibrations of the motors are propagated to the adjacent portion of the being's body and topically apply random-like mechanical stimulations to tendons or ligaments to stimulate proprioceptors of the being. Power for the motors is provided from a power and control source. The elastic wrap is formed of at least one material adapted that is soft and pliable. The motors are arranged to be located at various positions and orientations along the elastic wrap.

### CROSS-REFERENCE TO RELATED APPLICATIONS

This application claims priority from Provisional Application Ser. No. 61/374,812, filed on Aug. 18, 2010, entitled Mechanical Stimulation Wrap and Method of Use, which application is assigned to the same assignee as this application and whose disclosure is incorporated by reference herein.

### STATEMENT REGARDING FEDERALLY SPONSORED RESEARCH OR DEVELOPMENT

“Not Applicable”

### INCORPORATION-BY-REFERENCE OF MATERIAL SUBMITTED ON A COMPACT DISK

“Not Applicable”

### FIELD OF THE INVENTION

This invention relates generally to medical devices and more particularly to systems for application to a portion of the body, e.g., the leg, of a person for providing stimulation therapy, e.g., for relief of restless leg syndrome.

### BACKGROUND OF THE INVENTION

Between 3% and 15% of Americans experience Restless Legs Syndrome (RLS) symptoms, of these, an estimated 13 million Americans suffer moderate to severe RLS symptoms, occurring several times each week, and negatively impacting quality of life. The cause of this disorder is largely unknown. However, it has been associated with genetics, pregnancy, iron deficiency or anemia, chronic diseases, nerve diseases, polyneuropathy, and obesity. Some drugs, such as caffeine, alcohol, tobacco, some anti-seizure drugs, antidepressants, or allergy/cold medicines, and some anti-nausea drugs have also been associated with RLS.

RLS is typically characterized by four points of diagnostic criteria, as outlined by the International RLS Study Group (IRLSSG), and are defined below:

a. Desire to move the extremities usually associated with discomfort or disagreeable sensations in the extremities.

b. Motor Restlessness-patients move to relieve the discomfort, for example walking, or to provide a counter-stimulus to relieve the discomfort, for example, rubbing the legs.

c. Symptoms are worse at rest with at least temporary relief by activity.

d. Symptoms are worse later in the day or at night.

More specifically, sufferers of RLS report crawling, itching, stretching, tingling, burning, and boring pain in their legs, sometimes in their feet, and more rarely, in the arms and hands. These feelings are typically accompanied by an intense urge to move the affected limb; and in 80% or more of RLS cases, these sensations lead to involuntary movement of the affected limb. This involuntary movement is known as Periodic Limb Movement Disorder (PLMD). These symptoms typically follow circadian rhythms and occur mainly in the evening or night. However, symptoms may also occur any time of day if the individual is at rest for a long enough period of time. Movement often eases the symptoms; but often provides only very short-term relief. Changes to diet and lifestyle have also been associated with improved symptoms, though they do not serve as a cure or even necessarily provide total relief in the short or long-term.

Currently, the most effective solutions readily available to RLS sufferers are medications. These medications target areas of abnormality observed in RLS sufferers, such as iron deficiency and inhibited or reduced dopamine activity. These medications are fairly effective at reducing RLS symptoms in a majority of test subjects. However, they have numerous, potentially debilitating, and often intolerable side effects, only work when taken constantly, and are not always effective when taken properly.

Some alternative solutions focus on theories associating improved blood flow with improved RLS symptoms. One example is the belief that the application of compression to the affected area improves blood circulation, which may result in reduced symptoms of discomfort such as those associated with RLS. In support of this theory, some compression devices originally intended for use in the enhancement of venous and lymphatic drainage and prevention of the debilitating effects of a number of chronic circulatory diseases and other circulatory problems in the legs have been tested for use in RLS treatment.

A pneumatic compression device has been clinically tested for use in treating RLS symptoms with good success in many of the test subjects. However, this device involves the need for an air pump, which is very large and bulky. As a result, portability of this device is not realistic. Therefore, use of this device is restricted to settings in which movement for the length of time of the therapy is not desired or required.

Massage devices have been known to provide relief from muscular discomfort and pain, and may be accessed from compression, suction, thermal (hot or cold), and vibratory sources, among others. These devices, however, require someone to continuously hold the device over the target area for the extent of the massage. This eliminates the option of doing many other activities while using the device, while also eliminating the option of falling asleep while using the device. Another form of vibratory massage devices currently available are stationary foot massagers. The lack of mobility allowed with these devices has been countered by vibrating insoles or slipper type devices. However, these devices provide low levels of vibration, may be unwieldy and uncomfortable, may not be feasible for use during movement or out of doors, such as on an airplane, and may result in injury due to significant increases in pressure across small areas of the foot. Moreover, foot massagers do not address discomfort in other parts of the body.

The body has a natural tendency to adapt to continuous, unchanging stimuli from its environment. This is called neural adaptation or sensory adaptation. Sensory adaptation is defined by the American Psychological Association as “a phenomenon in which receptor cells lose their power to respond after a period of unchanged stimulation”. In other words, the continued application of the same, constant stimulus to a single location, results in a continuously decreasing number of nerve impulses triggered by decreasingly responsive receptor cells in reaction to that stimulus. However, this results in an increasing sensitivity of those cells to other, non-constant stimuli.

Many of these receptors, which are involved in providing feedback to the central nervous system in response to external stimuli are called mechanoreceptors or corpuscles. For example, Meissner corpuscles are layered, encapsulated receptors which are located in hairless (glaborous) skin, just below the epidermis and sense touch, movement and flutter. They signal velocity and direction and adapt quickly at a frequency in the range of 1-400 Hz (ideally in the range of 2-40 Hz). Pacinian corpuscles are layered, encapsulated receptors. They are located in deeper layers of hairy and glaborous skin. They sense touch and vibration and are most sensitive to vibration. They signal frequency and adapt quickly at a frequency in the range of 20-1500 Hz (ideally in the range of 20-300 Hz). Ruffini corpuscles are encapsulated collagen receptors. They are located in the dermis. They sense touch and skin stretch. They signal force and direction and adapt slowly at a frequency in the range of 0.1-240 Hz. Hair follicles are unencapsulated receptors. Nerve endings are located around the base of the hair follicle. They sense touch and movement and provide very precise encoding of the wavelength and magnitude of vibration. They signal velocity and direction and adapt fast at a frequency in the range of 1-1500 Hz. Merkel complex receptors are specialized epithelial cells. They are located in the lower margin of the epidermis, glaborous and non-glaborous skin. They sense touch, form and pressure and detect steady, maintained mechanical stimuli. They signal magnitude and location and adapt slowly at a frequency in the range of 0-30 Hz (ideally in the range of 5-15 Hz). Free nerve endings are unencapsulated receptors. They are located in the stratum granulosum of the epidermis. They sense touch, pain and temperature. They signal temperature change, tissue damage and contact and adapt at different rates (depending upon the information being carried) at a frequency in the range of 0-15 Hz.

While many of these mechanoreceptors are located in the skin (cutaneous), other tissues of the body are also heavily innervated with sensory neuronal structures, including, but not limited to those described above. For instance, free nerve endings exist among the muscle spindle afferents in muscle tissue. Pacinian and Ruffini corpuscles have been found throughout the capsule of the knee. Finally, nerve fibers and proprioceptors have been identified throughout tendons and ligaments.

Proprioception is typically defined as the ability to sense the location, orientation, position and movement of the body and its components with respect to each other. Many sufferers of restless legs syndrome find temporary relief with changes in position, standing up, walking, etc. This has lead to the theory that the irritating sensations associated with restless legs syndrome may be, at least temporarily, reduced or eliminated by proprioception. Some studies have sought to test the body's proprioceptive response to both local and broad vibratory stimuli. From these studies, free nerve endings which stimulate muscle spindle afferents, have shown responsiveness to vibratory stimuli, in particular that which is applied to the tendons. Similarly, cutaneous receptors (receptors located in the skin) have been associated with proprioceptive response due to vibration, skin stretch, etc. Further, Proprioceptors are located in the joints, muscle spindle afferents, and tendons. Mechanoreceptors are mostly located in the skin. Therefore, the highest concentration of receptors which will most likely produce the greatest effect on RLS symptoms exist nearest joints, where all of the following receptors may be stimulated: mechanoreceptors in all layers of the skin covering the joint; proprioceptors located within the joint in the ligaments, which connect bone to bone; proprioceptors and mechanoreceptors located in the fluidic capsule; and proprioceptors located in the tendons, which connect bone to muscle, and which trigger the stimulation of nearby muscle spindle afferents when vibrated

The receptors in the skin, however, while they produce a more accurate movement perception when crossed with feedback from muscle spindles, are less accurate for proprioception than those located in the joints.

The Pacinian and Ruffini corpuscles in the fluidic capsule of the knee and other joints also serve to contribute to proprioception as well as reflex inhibition. Pacinian corpuscles are responsive mainly to vibration stimuli. Other studies have identified upwards of 14 different capsule receptors which are responsive to vibration, 11 of which could be driven at different frequencies. Feedback from these receptors triggers proprioceptive activity.

Existing vibratory massage devices tend to produce a monotone, or unchanging, single vibration signal. Such a signal is easily adapted to, in much the same way as a person adapts to a constantly applied pressure: noticing the pressure change at first; but no longer feeling the pressure after it is applied continuously for a time, until a change is made. Current device solutions are also very structured, minimally adjustable and shaped for a specific region of the body only. Nerves which control the contraction and dilation of blood vessels, and along which the signals from the corpuscles in the skin and the nerve endings in the muscles travel are located deep in the tissue throughout the majority of the lower body. These nerves tend to be located closest to the skin in a limited number of places, including the knee area, the ankle/foot area, and the lower back. Targeting these nerves may be most effectively done by transferring the mechanical stimulus through harder tissues, such as tendons, which may act more like the taut strings of a musical instrument which carry vibrations well. Softer tissues, such as muscle or fat, may act more like a damping force absorbing much of the vibration stimuli before it reaches the deeper nerves.

The patent literature includes disclosures of devices used for treating RLS by applying vibration to portions of the leg. See for example, US 2009/0221943 (Burbank et al.) and WO 2009/136931 (Walter et al.)

Notwithstanding the existence of the foregoing prior art devices and patent applications, a need remains for a non-pharmacological, truly portable, comfortable, low-risk, solution which provides therapeutic counter stimulation to the leg and potentially to the foot areas of the body without creating increased pressure over a small surface area of the body. The subject invention addresses that need.

### SUMMARY OF THE INVENTION

In accordance with one aspect of this invention there is provided a system for applying therapeutic mechanical stimulation in the form of vibratory energy to a portion of the body of a living being, e.g., to treat restless leg syndrome. The system basically comprises a holding member, e.g., an elastic band or wrap, and at least one mechanical stimulation producing device, e.g., a electrical vibrating motor. The at least one mechanical stimulation producing device is held by the holding member, e.g., arranged to be clipped onto the holding member at any desired position therealong. The holding member is arranged to be releasably secured to the portion of the body of the being to cause the at least one mechanical stimulation producing device to topically apply the mechanical stimulation to the portion of the body of the being. The mechanical stimulation automatically varies in at least one of amplitude and frequency, whereupon the mechanical stimulation is perceived by the being as non-predictive or random-like.

In accordance with one preferred exemplary embodiment of the invention the system additionally comprises an actuatable power and control source which is coupled to the at least one mechanical stimulation producing device, whereupon when the power and control source is actuated it causes the at least one mechanical stimulation producing device to produce the mechanical stimulation.

In accordance with one method aspect of the invention the mechanical stimulation is provided to a portion of the body of the being for relief from various conditions, e.g., restless leg syndrome and can be targeted to specific portions of the being anatomy, e.g., tendons and/or ligaments.

### DESCRIPTION OF THE DRAWING

FIG. 1A is a plan view of the outer side of one exemplary embodiment of a system constructed in accordance with this invention for providing mechanical stimulation to a portion of the body of a living being;

FIG. 1B is a plan view of a portion of the inner side of the exemplary embodiment of a system shown in FIG. 1A;

FIG. 1C is a longitudinal sectional view taken along line 1C of FIG. 1A;

FIG. 2 is an enlarged isometric view of one portion of one exemplary preferred embodiment of a mechanical stimulation producing device, e.g., an electrical vibrating motor, used in the system of FIG. 1A;

FIG. 3 is a longitudinal cross-sectional view of the mechanical stimulation producing device shown in FIG. 2;

FIG. 4 is an enlarged isometric view of the mechanical stimulator assembly, i.e., a pair of mechanical stimulation producing devices and their associated cables which are connected via a connector or plug to a power and control module of the system shown in FIG. 1A;

FIG. 5 is an enlarged cross sectional view of a portion of the elastic wrap or band forming a portion of the system shown in FIG. 1A, i.e., the releasable fastener system, e.g., hook and loop components, used to hold the wrap in place on a desired portion of the body of the being;

FIG. 6 is an enlarged front isometric view of the exemplary preferred embodiment of the power and control module forming a portion of the system shown in FIG. 1A;

FIG. 7 is an enlarged rear isometric view of the power and control module shown in FIG. 6;

FIGS. 8A-8E are a series of reduced size plan views of possible alternate shapes of the elastic wrap portion of the system of this invention;

FIGS. 9A-9C are graphs showing the mechanical stimulation provided by the system of FIG. 1A in three user-selectable modes of operation;

FIG. 10 is a block diagram of the electrical components making up the system shown in FIG. 1A;

FIG. 11 is an isometric view of an alternative, exemplary embodiment of another system constructed in accordance with this invention for applying mechanical stimulation to a portion of the body of a living being;

FIG. 12 is an enlarged cross-sectional view of the elastic wrap portion of the alternative system shown in FIG. 11;

FIG. 13 is an enlarged plan view of a portion of the elastic wrap shown in FIG. 12;

FIG. 14A is an enlarged isometric view of a double-component power and control module which can form a portion of the alternative system shown in FIG. 11;

FIG. 14B is an isometric view of a single-component power and control module which can form a portion of the alternative system shown in FIG. 11;

FIG. 15A is a graph illustrating the Fast Fourier Transform (FFT) calculations of the baseline, or background noise vibration output produced by the system of FIG. 1A;

FIG. 15B is a graph illustrating the FFT calculations of the vibration output of a stock (prior art) vibratory massage device as collected over 20 seconds;

FIG. 15C is a graph illustrating the FFT calculations of the vibration output of the system shown in FIG. 1A, with user selectable settings set to Mode 2, Intensity 1 (to be described later), and no pulse as collected over 20 seconds;

FIG. 15D is a graph illustration the FFT calculations of the vibration output of the system shown in FIG. 1A, with user selectable settings set to Mode 2, Intensity 4 (to be described later), and no pulse as collected over 20 seconds;

FIG. 15E is a graph illustrating the FFT calculations of the vibration output of the stock (prior art) vibratory massage device as collected over 4 seconds;

FIG. 15F is a graph illustrating the FFT calculations of the vibration output of the system shown in FIG. 1A, with user selectable settings set to Mode 2, Intensity 1, and no pulse as collected over 4 seconds; and

FIG. 15G is a graph illustration the FFT calculations of the vibration output of the system shown in FIG. 1A, with user selectable settings set to Mode 2, Intensity 4, and no pulse as collected over 4 seconds

### DETAILED DESCRIPTION OF THE PREFERRED EMBODIMENT

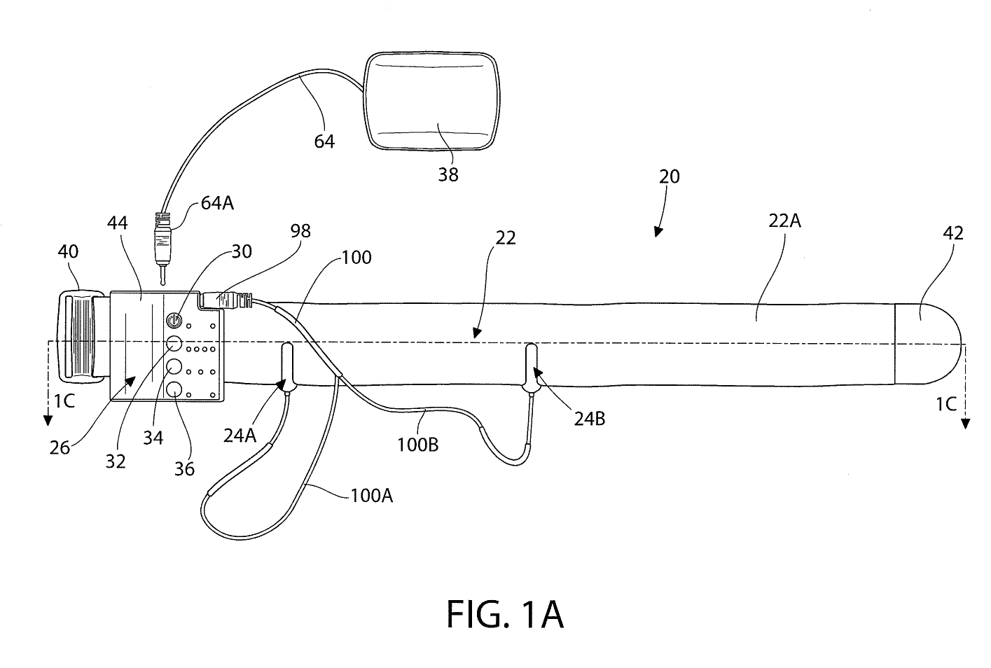

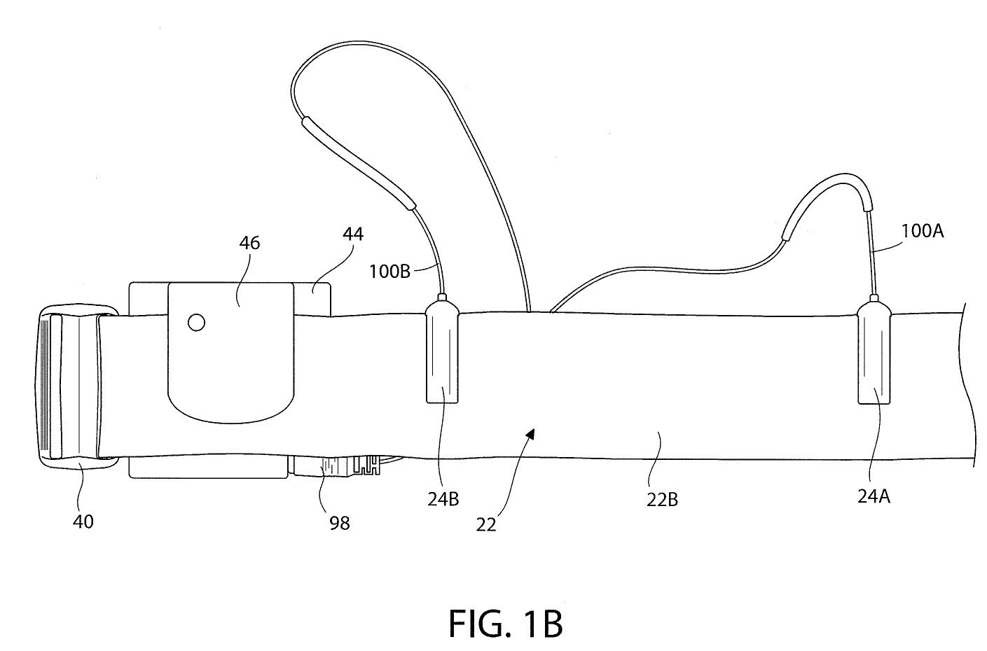

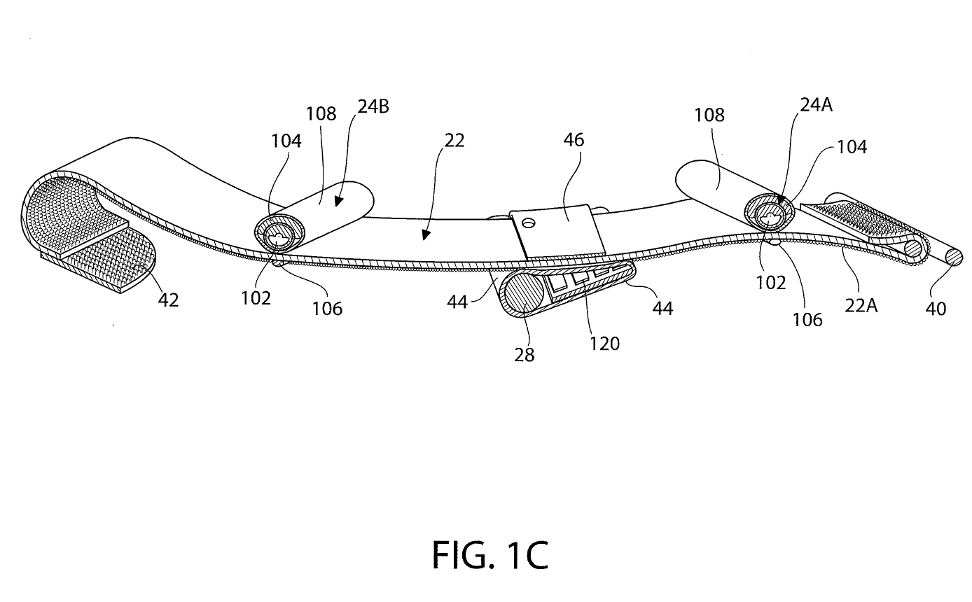

Referring now to the various figures of the drawing wherein like reference characters refer to like parts, there is shown in FIG. 1A a system 20 for providing mechanical stimulation, e.g., vibratory energy, to a portion of the body of a living being. As is known, living beings exhibit what is known as neural adaptation or sensory adaptation, i.e., a change over time in the responsiveness of the sensory system to a constant stimulus. The subject invention counters this effect by applying counter mechanical stimulation to a portion of the being's body in a manner that the body perceives as being random or non-predictive for a beneficial, e.g., therapeutic effect. As will be described later the system 20 applies the mechanical stimulation in a pattern which changes in amplitude and/or frequency more than twice per minute, or in several distinctly different specific, yet undetectable patterns to control both amplitude and frequency.

The system 20 basically comprises an elastic band or wrap 22, a pair of mechanical stimulation producing devices, e.g., electrical vibration motors, 24A and 24B, and a power and control module 26. As will be described in detail later, the system is arranged to provide mechanical stimulation to a portion of the body of a living being for a beneficial effect, e.g., relief from RLS symptoms. This is accomplished by topically applying a constantly changing, mechanical stimulation, to the affected area in an adaptable, light weight, small, removable, and low-risk manner. Further, this transmission of mechanical stimulation is aided by the shape, flexibility, and elasticity of the elastic wrap 22, which allows the user to apply the wrap around the affected limb (or other portion of the user's body), with the devices 24A and 24B over or near the affected area or targeted nerves/tendons, and releasably secure the system in a comfortable and stable manner, to that area. The construction and materials chosen for use in this wrap will be described later. Suffice it for now to state that they are designed to allow easy placement of the mechanical stimulation along the wrap portion of the device, while maintaining a soft, pliable, non-irritating aspect, which prevents potential chafing, itching, or other adverse response from the user.

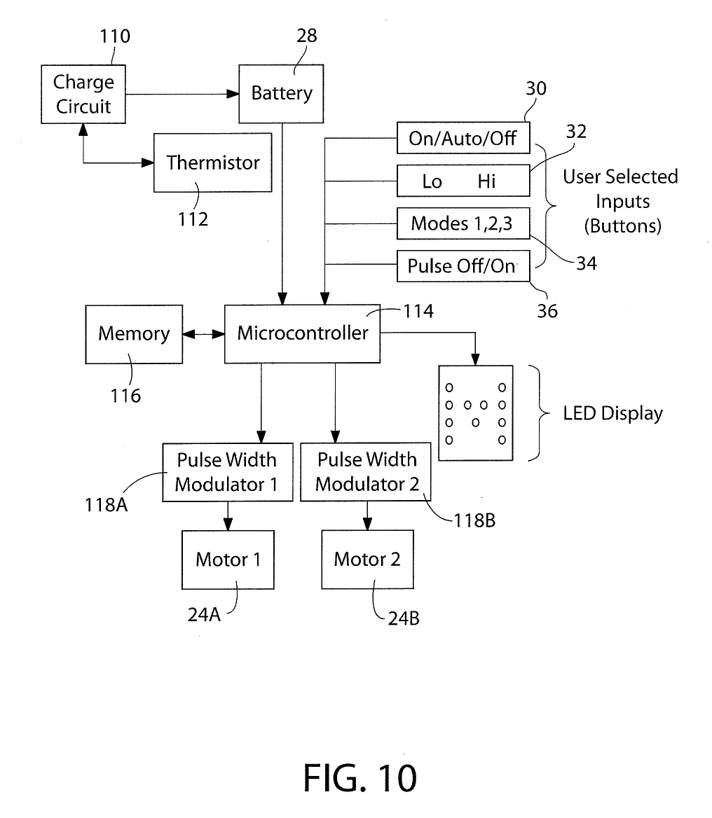

The power and control module 26 will also be described later. Suffice it to state for now that it is contained in a small, lightweight housing 44 (shown in FIGS. 6 and 7) and includes a low-voltage rechargeable battery 28 (FIG. 10), an on-off and timer switch or button 30, an intensity adjustment switch or button 32, a “mode” selection switch or button 34, and a “pulse” switch or button 36. The battery is arranged to be charged from a charger 38.

The power and control module 26 is constructed to be resistant to short circuits and battery overheating, which may be potentially hazardous. In addition, it is arranged to prevent accidental connection of the charger or motors to an incorrect outlet.

The system 20 is lightweight and small and is therefore highly portable, to allow the user to comfortably wear the device while sleeping, walking, or otherwise engaging in activities which may result in movement. The system is also designed to maximize the effect of the therapy, by providing an output mechanical stimulation of widely varying amplitudes and frequencies. Further, the output frequencies vary between 0 Hz and 1,550 Hz dozens of times per second. Finally, the device also is designed to maximize customizability for a wide range of sizes, shapes, and preferences.

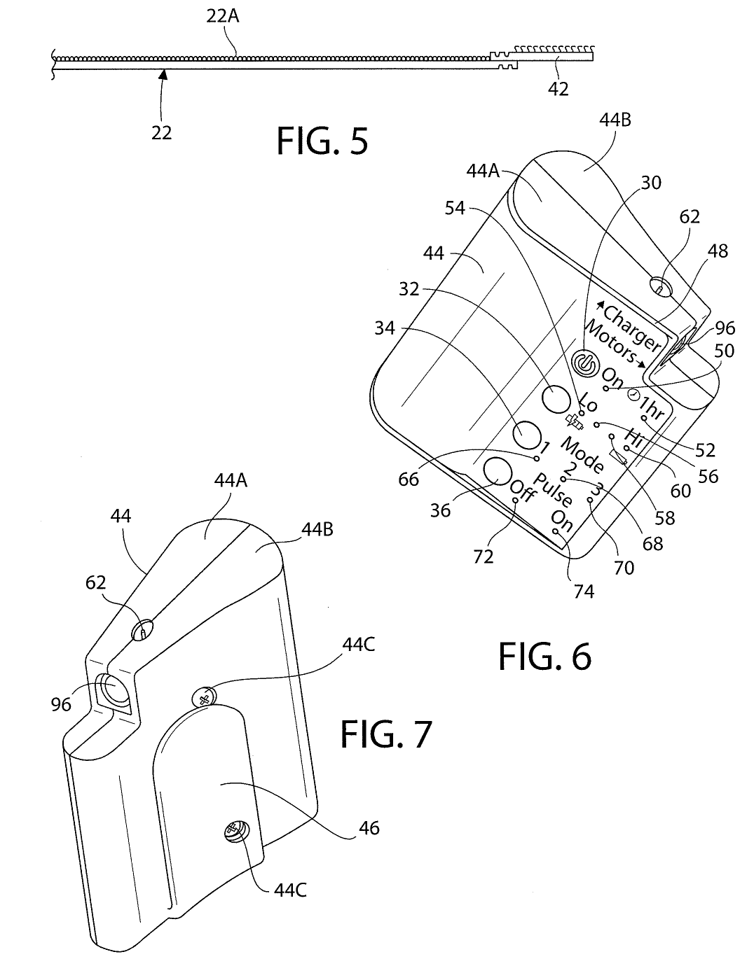

The elastic wrap 22 is shown in FIGS. 1A, 1B, 1C and 5 and is in the form of an elastic band with a soft loop structure on its outside surface 22A as best seen in FIG. 5. A rectangular plastic ring 40 is fixedly secured to one end of the band. The other end of the band is in the form of a tab 42 having multiple hooks for releasable securement to the loops of the surface 22A. With this arrangement the inner surface of the band can be placed into contact with the portion of the user's body to be treated, e.g., the user's leg, and wrapped thereabout, with the end of the band having the tab 42 extended through the ring 40 and folded over into engagement with the loop outer surface 22A of the band to hold it in place.

In accordance with one exemplary embodiment of this invention the band 22 is available from Perfectex Plus, LLC under the trade designation 2″ elastic loop, PN: 2014ELT. Similar bands are also available from Lea & Sachs, Inc., under the trade designation 2″ Stretch “Y” Loop Black. The ring 40 is available from Fasnap Corp., under the trade designation Standard 2″ Loop. It is also available from Homa Locks, under the trade designation Common Loop Black Acetyl PN: 40I 4581 BLK 2″, or from UMX, Inc., under the trade designation Square Ring 2″ PN: P001. The tab 42 is available from Perfectex Plus, LLC, under the trade designation ETN 21 or Clear Mushroom, or is available from Velcro USA, Inc., under the trade designation Hook 88 2″ Navy 145 Sew-On 0199 PN: 190757. The tab is ultrasonically welded onto the main, looped, elastic band 22 such that the hook structures of the tab are facing the same direction as the loop structures of the band as clearly shown in FIG. 5.

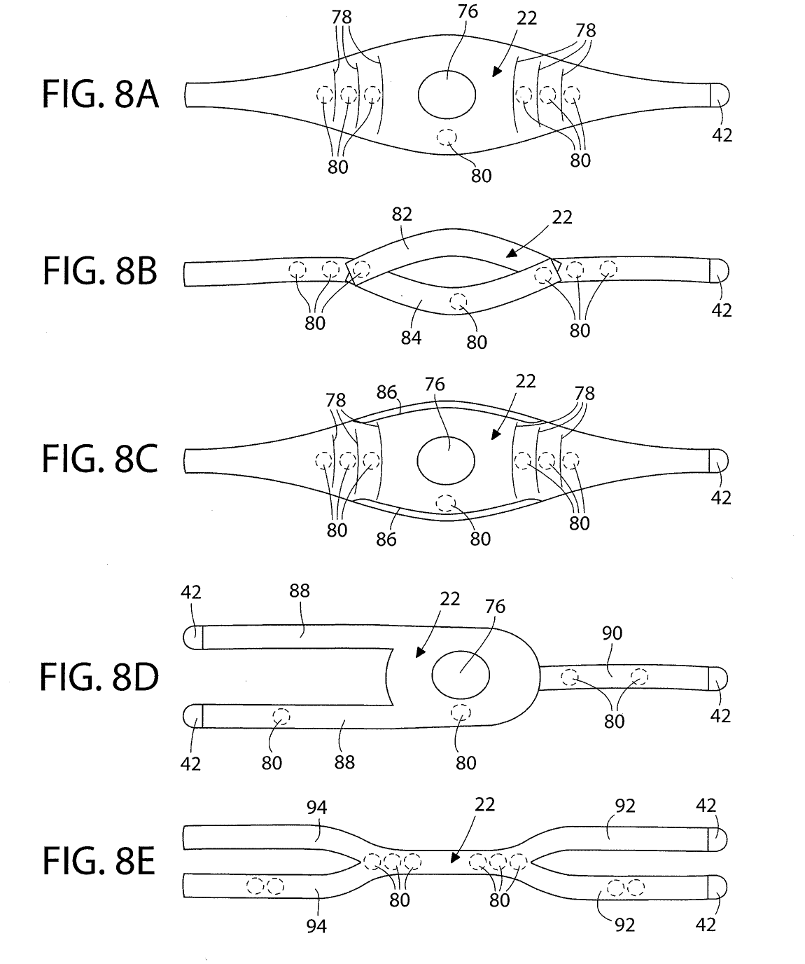

As shown and described above, the preferred embodiment of the band or wrap 22 is in the form of a single, rectangular strap. However, other embodiments are also possible. Such embodiments might include forms which exist in many currently available products for bracing or supporting knees, ankles, wrists, forearms, etc. Such shapes might include, but are not limited to those shown in FIGS. 8A-8E (which will be described more fully later). Alternate embodiments might also include, in any of these shapes, a number of base materials such as felt, neoprene, foam, nylon, rubber, etc.

The motors 24A and 24B will be described in detail later. Suffice it for now to state that each is an electrically operated motor, which is arranged to produce a vibratory output when driven by an associated pulse width modulator (to be described later) forming a portion of the power and control module 26. The pulse width modulators are in turn controlled by a microprocessor also forming a portion of the power and control module. The vibratory energy that is produced by the motors is designed to be such that it appears random and non-predictable to the user. It is those random-like vibrations, which vary in amplitude and/or frequency, which produce the beneficial effect of the subject invention. Those vibrations are produced in response to a program run by the system's microprocessor in accordance with a program stored in the system's memory. Thus, even though the program is repetitive, it repeats over such a long period of time that the user perceives the changes in amplitude and/or frequency of the vibrations to be random or non-predictive.

The various electrical components making up the power and control module are shown in FIG. 10 and will be described later. Suffice for now to say that those components are located in the aforementioned housing 44 (FIGS. 6 and 7). That housing is very compact, e.g., it measures no greater than 2.7″ by 3″ by 1″ and has a rounded, ergonomic shape with no sharp edges or corners, since the housing is arranged to be mounted, e.g., clipped onto the band 22 and worn by the user. To that end, the control module's housing 44 incorporates a low-profile belt-clip 46 (FIG. 1B) that fits snugly on the band 22, but is still able to slide along the band with relative ease. The housing includes a front face on which the various user interface controls, e.g., buttons and LED's are located. In addition, the housing includes connectors or sockets (to be described later) to which cables for carrying the electrical signals to the motors and for charging the battery from the battery charger, are connected.

The power and control module may be formed of ABS or similar strong, shatter-resistant plastic or even lightweight metal and includes various indicia, e.g., text and graphics, on its outer surface located adjacent various of its user interface controls to enable the user to readily ascertain the user feature to be addressed. That indicia can be provided by means of a label fixedly secured to the outer surface of the housing 44. In the interest of ease of use, the label bearing the indicia is arranged so that the indicia is upside down from the belt clip. Accordingly, when the control module 26 is mounted on the band 22 and positioned on the leg of a user, the user can read the text/graphics easily, without having to pull the control module off of the band to turn it around to be readable.

As best seen in FIG. 6, the housing 44 is in the form of two half shells 44A and 44B which meet together flush and are held together with one or more screws 44C. If desired, a gasket (not shown) may be provided between the two halves to prevent water from entering the housing. The housing includes a raised ridge 48 (FIG. 6) which partially surrounds the user interface. This ridge prevents the buttons of the user interface from accidentally being pressed if rolled over on or sat on. The ridge meets with a slight rise on a third side of the housing immediately next to the buttons to further this goal. Other methods for preventing accidental button pressure might include a separate locking button, switch, or slide, and/or a cover for the buttons. Alternatively, a programmed feature wherein pressing/flipping and/or holding one or more buttons, switches, or slides at the same time might engage and/or disengage a locking mechanism, which, when engaged renders all buttons, switches, or slides unresponsive to momentary, irregular, or un-patterned pressing, switching or sliding until the unlocking pattern is applied.

As mentioned above, the housing 44 includes a clip 46 for mounting it on the band 22. As best seen in FIGS. 1B and 7, the clip is attached to the back of the housing via a screw 44C. Alternatively, the clip can be connected to the housing by a snap feature. In fact, the two half shells of the housing can be connected together by a snap feature in lieu of the use of screws. The housing 44 may also include a hinge so that the two portions can be opened up to provide access to the components within its interior. The housing also includes a socket or connector (to be described later) which enables the power and control unit to be charged by the charger 38 and a socket or connector (also to be described later) which provides the electrical signal to drive (power) the motors 24A and 24B.

The user interface comprises the heretofore identified On/Off/1 Hour timer button 30, the Lo-Hi (intensity) button 32, the “mode” button 34, and the “pulse” button 36. The On/Off/1 hour timer button 30 is provided to turn the system on and off. To that end, it is coupled to the system's microprocessor to enable the user to turn the system on by pressing the button 30 once. Doing so starts the motors 24A and 24B vibrating. They will continue to vibrate until the user presses the button again to turn them off or until the battery is exhausted. Thus, by pressing on the button 30 once the user can start the system running and then at some later time by pressing the button again can turn the system off. Accordingly, the user can run the system for however long the user wishes.

The button 30 also serves as a timer/auto shut-off switch. In particular, the button is coupled to the microprocessor in the power and control module. The microprocessor is programmed to turn off after one hour when the button 30 is initially pressed twice. This arrangement allows the user to relax or sleep while using the device and have it shut itself off, without running out of battery power, or waking the user by a sudden shut-off. This function may also be used to restrict the length of the therapy time the user may be able to apply, in which the system locks itself in the off position once the set amount of therapy is given, and does not unlock for a period of time such as one to seventy-two hours. The timer can also be programmed by the manufacturer to other lengths of time such as 15, 20, 30 minutes, or even a set of hours within the limitations of the battery run-time. Moreover, it is preferred that the operation of the time-out not be abrupt, i.e., not stop immediately upon reaching the end of the time-out period, to ramp down gradually, e.g., to go from full intensity to off in a two minute time period. This ramp-down function has the effect of being somewhat less noticeable or shocking to the user. For example, if the user is sleeping the ramping down will be less noticeable than an abrupt off, which latter action could result in waking the user.

The functions of “On” and “1 hour timer” are displayed by two LEDs 50 and 52 (FIG. 6) positioned directly to the right of the button 30, and below the text denoting what they represent (for instance: “On”). The leftmost LED 50 which is directly under the text “ON”, lights when the standard ‘On’ function is selected. The rightmost LED 52 which is located below the text “AUTO OFF” or “1 Hour”, lights when the timer is selected. Other ways to symbolize the timer may include a clock symbol, an hourglass, the text “TMR”, “Time”, “1 hr”, or combinations of these texts and/or symbols, etc.

The system 20 is designed for maximum flexibility of use by various users for various conditions or applications. To that end, the system enables the user to set their preferred base intensity across four distinct intensity levels for the vibrations provided by the vibratory motor devices in any of its operating modes (to be described shortly). That action is accomplished by use of the Lo-Hi button 32. Each of these intensity levels is indicated by a separate LED located directly next to the button 32, and below the text “LO to HI”. These LEDs light one at a time, from the left to the right as the intensity increases. In particular, each time that the Lo-Hi button is pressed the intensity level of the vibrations provided by the vibratory motors is increased by a percentage or to a preset base value for that particular setting. For example, pressing the Lo-Hi button 32 once may establish the base intensity at a level X, whereas pressing the Lo-Hi button twice may establish the base intensity at a level 2×, etc. In the exemplary embodiment there are four distinct levels of base intensity that can be established, so that the user can tailor the intensity of the vibrations to a setting which is appropriate for that user. The power and control module includes four LEDs, namely, 54, 56, 58 and 60. These LEDs are located adjacent the Lo-Hi button 32. The setting of the intensity level from low to high is represented by the illumination of LEDs 54, 56, 58 and 60, respectively.

These LEDs also serve as a charge indicator by the leftmost LED 54 flashing slowly to indicate charging of the battery, and the rightmost LED 60 lighting solidly to indicate a fully charged battery. Alternative methods for indicating the charging and charged states include one or all of any of the existing LEDs flashing slowly when the battery is charging and one or all lighting solidly when the battery is charged. An alternative option may be a new LED or other indicator altogether, which only serves as a charge indication, and which may therefore indicate both of either charging or fully charged while the device is off. This function is only activated by plugging in the charger/wall adapter 38 to the control module 26 and also to a working outlet (i.e. when a current and/or voltage are supplied to the circuit board in the power and control module from the charge connector); and may only be indicated when the power and control module is turned off. The charging function itself is programmed to automatically shut the system off in response to a voltage supplied to the charge connector on the power and control module circuit board.

For the charging and running functions, the module 26 includes the heretofore identified battery 28. That battery is preferably 3.7 Volt, 14500 Li-ion rechargeable battery. The low-voltage nature of this power source reduces the risk of electrically-related adverse events, which may potentially cause harm to the user. This also simplifies the use of the system by preventing the need of the user to open the power and control module to extract and replace batteries. A port 62 (FIGS. 6 and 7) is provided in the housing 44 for receipt of a charge cable connector 64A (FIG. 1A) from the charger 38.

To further its flexibility of use, the system 20 is programmed to establish plural, different, modes of operation. In the exemplary embodiment three such modes are available. Those modes are a soft mode (referred to as “Mode 1”), a more robust or rough mode (referred to as “Mode 2”) and a uniform (no-varying) mode (referred to as “Mode 3”).

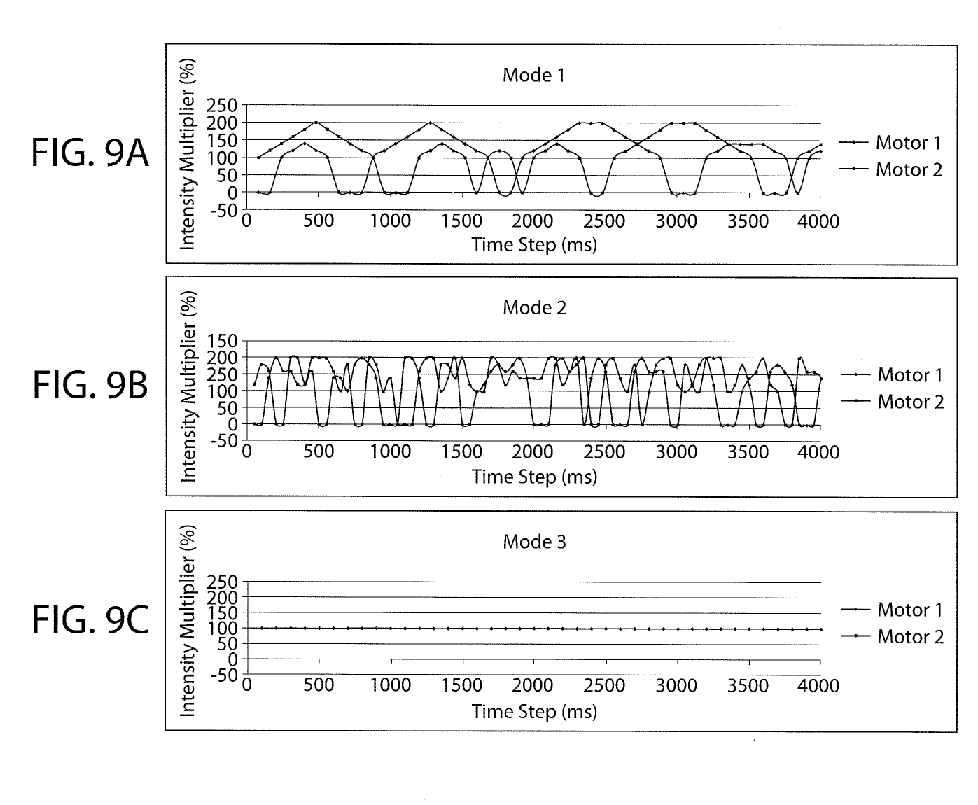

Mode 1 encompasses a number of widely-varying frequencies and amplitudes that constantly, but gradually change, within the limits of the user's other settings (such as intensity, pulse, and timer/on). To that end, in the Mode 1, whose output frequency and intensity program for motors 24A and 24B is shown by the graph in FIG. 9A, the amplitude and frequency are changed in gradual steps as a percentage of the intensity set by the button 32, with the amplitude change being a percentage of the base intensity that the user has set. For example, if the user has the intensity setting on the lowest intensity (represented by the illumination of LED 54) the amplitude might at some point be twice that intensity level. So that if the intensity level set is 20% of the battery output, it might be 40% of the battery output at the maximum possible amplitude. The soft mode changes the frequency and amplitude in gradual, dynamic steps, e.g., it may change from 100% of the intensity to 120%, then to 140%, then to 160%, then back down to 140%, then to 120% and back to 100%. The time steps between changes is presently set to be 80 milliseconds, to provide a slower change which appears less abrupt to the user. It should be pointed out at this juncture that the use of 80 millisecond time steps is merely exemplary so that other time steps can be used.

Mode 2 is a ‘rough’ vibration mode, whose signal varies much more drastically and suddenly than the ‘soft’ signal, within the limits of the user's other settings. In Mode 2, whose output frequency and intensity program for motors 24A and 24B is shown by the graph in FIG. 9B, there are shorter time steps, namely 50 millisecond time steps, so that the changes in amplitude and/or frequency occur more quickly. Moreover, the amplitude changes are more pronounced, e.g., from 100% intensity directly to 160%.

In Mode 3, whose output frequency and intensity program for motors 24A and 24B is shown by the graph in FIG. 9C, the vibrations produced by the motors are constant in frequency and amplitude, e.g., are monotone-like, similar to the vibrations produced by conventional vibrators.

Each of these three modes is denoted by indicia and LED located on the housing adjacent the button 34. In particular, there are three separate LEDs 66, 68 and 70 located directly next to the button 34, and below the text for each mode: “1” “2” or “3”. These LEDs light from left to right as the selected mode number (1, 2 or 3) increases.

All three modes of operation loop continuously until a setting is changed or the system is shut off. Many variations on these three programs, particularly Modes 1 and 2, which involve changes to either frequency or amplitude or both more than 2 times per minute, and in the sensory range of the known corpuscles (0 Hz-1500 Hz), may also be successful for this application with varying impact on neural adaptation and the stimulation of more than one corpuscle. Wider variance of frequencies changing more frequently over time may help to stimulate more corpuscles more frequently. This may increase the likelihood that the signals interpreted as the restless legs symptoms are more likely to be blocked by the signals sent by the corpuscles in response to the counter stimulation, making each minute of therapy more effective.

These programs, while appearing to be random in reality are continuously looping patterns. They have been experimentally undetectable as patterns by various test subjects for which a system constructed in accordance with this invention has been used. Modes 1 and 2 also strive to prevent sensory adaptation by varying in both amplitude and frequency rapidly and across a wide range. For instance, the amplitudes vary between 0 and 200 times the user's intensity setting, while the frequencies vary between 0 Hz and 1550 Hz. The time steps for these changes occur at 50 milliseconds and 80 milliseconds. The final mode, Mode 3 is a basic, single, monotone vibration signal, which remains unchanged within the limitations of the user's other settings. While constant and unchanging at 100% of the user's chosen intensity, the microprocessor reads and applies this data at 100 millisecond time steps.

The system 20 is also constructed to provide a “pulse” mode. In that mode the vibrations are repeatedly turned on and off so that the stimulus provided by the vibratory motors is not continuous. The pulse mode is initiated by the user pressing the “pulse” button 36. In the exemplary embodiment shown, the pulse mode causes the motors to vibrate for 5 seconds and then stop vibrating for 5 seconds and then to repeat that sequence. Thus, the total cycle time is 10 seconds. This sequence continues for the duration of the time established by the on/off button 30, e.g., until the user manually turns the system off, or until the battery is exhausted, or until the one hour timer times out (as the case may be).

The setting for non-pulsing, or continuous vibration, is indicated by an LED 72, which is located immediately to the right of the button 36, and below the text “OFF” which appears just below the text “PULSE”. The setting for pulsing vibration is indicated by another LED 74 located to the right of LED 72 and below the text for “ON”.

The pulse function is present in the preferred embodiment to give the corpuscles a set amount of time to reset. The idea is to further counter sensory adaptation by temporarily removing the mechanical stimulus from the area for a time before reapplying the stimulus. This may allow for corpuscles, which might have been to any degree desensitized to the mechanical stimulus, to recognize the reapplication of the stimulus as an altogether new stimulus, thereby causing them to send more signals than they might have previously done. Though the cycle time for the preferred embodiment is proposed to be 10 seconds (5 seconds on, 5 seconds off), the cycle time for the pulse may be any other combination of on times and off times provided that the system changes three or more times per minute. The on and off times for such cycles may be equivalent, such as 10 seconds on, 10 seconds off, or they may be different, such as 20 seconds on, 5 seconds off. For example, the on-time can be anything in the range of up to one minute, anything in the range of one minute to one hour, anything in the range of one hour to three hours or anything up to the end of the battery's life. Moreover, the ratio of on-time versus off-time can range from 10:1 to 1:10, or from 5:1 to 1:5, or from 100:1 to 1:100, or from 1:3600 to 3600:1 and anything in between any of those ranges.

As will be appreciated by those skilled in the art, the tendons and ligaments, being harder structures than muscle and skin, tend to propagate vibration better than muscle and skin. In addition, as discussed above, the tendons and ligaments have proprioceptors and mechanoreceptors inside of them and also in direct contact with them in the adjacent tissue which are more evenly stimulated by vibration of those tendons/ligaments. Those specialized receptors are very sensitive to vibration in various ranges of frequency and amplitude and convert those stimuli from the vibration motors into signals to the brain. Thus, in accordance with a preferred aspect of this invention the vibration motors are arranged to be disposed closely adjacent tendons/ligaments of the portion of the user's body to be treated. However, such placement is not mandatory, so that the motors can be placed at any desired position on the user's body that is appropriate for the treatment to be given

It should be pointed out at this juncture that in the exemplary embodiment of the apparatus 20 the vibratory energy provided to the user is achieved by means of the vibrating, electrical motors 24A and 24B. Other types of devices can be used to produce the vibratory energy, e.g., it can be produced pneumatically, hydraulically or electrically (e.g., through use of piezoelectric transducers or some other electrical-to-mechanical energy transducer). Moreover, the number of vibratory devices to be used in a particular system is dependent upon the treatment to be provided and the anatomy to which the treatment is to be applied.

FIGS. 8A-8E show various exemplary embodiments of a knee wrap or band constructed in accordance with this invention and particularly suited for targeting the tendons and ligaments of the knee and contiguous anatomy. To that end, FIG. 8A shows a knee band or wrap 22 having an opening 76 for the patella and includes lines or other indicia 78 to indicate where the motor(s) that are used in the system could be placed to target a particular tendon or ligament for the knee joint and capsule. The potential location for any of the motors adjacent the indicia, is shown schematically by the broken circles 80. A tab 42 is located on one end of the band for releasable engagement with a portion of the loop surface of the end of the band when the band is wrapped about the knee. The band 22 can be of any width. One exemplary band has a width of approximately 6.5 inches at the knee, with the ends of the band having a width of approximately 1 inch. These values are merely exemplary of any number of sizes for the band.

FIG. 8B show a knee wrap in the form of a band 22 composed two arcuate to centrally located straps 82 and 84 which overlap to form an opening for the patella. A tab 42 is located on one end of the band for releasable engagement with a portion of the loop surface of the end of the band when the band is wrapped about the knee. Indicia are also provided to indicate the position of where a motor should be placed for the patella tendon and for the inside and outside hamstring tendons. The potential location of those motors is shown by the broken circles 80.

FIG. 8C shows a knee wrap 22 similar to the wrap of FIG. 8A, but including a tacky, e.g., a silicone or rubberized, stripe 86 along its peripheral edges on the inner surface of the wrap. The stripe serves to provide additional resistance to the wrap slipping from its desired position.

FIG. 8D shows another variant knee wrap 22, having a central section with a patella opening 76 and two straps 88 extending from one side of the central section and a single strap 90 extending from the other side of the central section. A tab 42 is located on the end of each strap for releasable engagement with a portion of the central section of the wrap when the straps are wrapped about the knee. Indicia are also provided to indicate the position of the where a motor should be placed for and the location of those motors is shown by the broken circles 80.

FIG. 8E shows still another variant knee wrap 22 whose central section is arranged to be located on the rear of the knee, and having two pairs of parallel straps 92 and 94 projecting from opposite ends of the central section. The central section can be of any size, with 2.5-3 inches being particularly useful, and with the maximum width of the band being 6.5 inches, with each of the straps being from 1.5 to 2 inches. A tab 42 is located on the end of each strap 94 for releasable engagement with the end of a respective strap 92 when the straps are wrapped about the knee. Indicia are also provided to indicate the position of the where a motor should be placed; and the location of those motors is shown by the broken circles 80.

As best seen in FIGS. 6 and 7, the power and control module includes a socket or connector 96 which is arranged to receive a mating connector or plug 98 (FIG. 4) of a cable 100. The cable 100 serves to provide the driving power to the motors 24A and 24B and thus includes two branches 100A and 100B electrically connected to motors 24A and 24B, respectively. The plug 98, the cables 100A and 100B and the motors 24A and 24B form a modular unit, which can be referred to as the mechanical stimulator assembly. The plug 98 is a rectangular 4-pin connector, whose four separate pins prevent the occurrence of short circuits when plugging and unplugging the connector. The plug 98 also includes a locking hook (not shown) to prevent accidental removal of the mechanical stimulator assembly, as well as to ensure a secure connection has been made. In contrast, the battery charger 38 (e.g., a wall adapter) uses a barrel connector 64A to be received within the socket or connector 62 in the power and control module housing 44. The significant differences between the two connectors 98 and 64A prevent the user from accidentally connecting the wrong device to the wrong connector, which could cause circuit problems. Markers or other indicia may or may not be included on the label on the housing, which point to the charge port and/or the mechanical stimulation port and/or call these ports out as “Charge” or “Motors”. Other labeling that might be used for the charge port include uppercased, lowercased, or mixed case text such as “CH”, “Chrg”, “Chg”, “Chg Port”, etc. Other text that might be used for the mechanical stimulation port include “STIM”, “VIB”, “STIM Port”, “VIB Port”, etc.

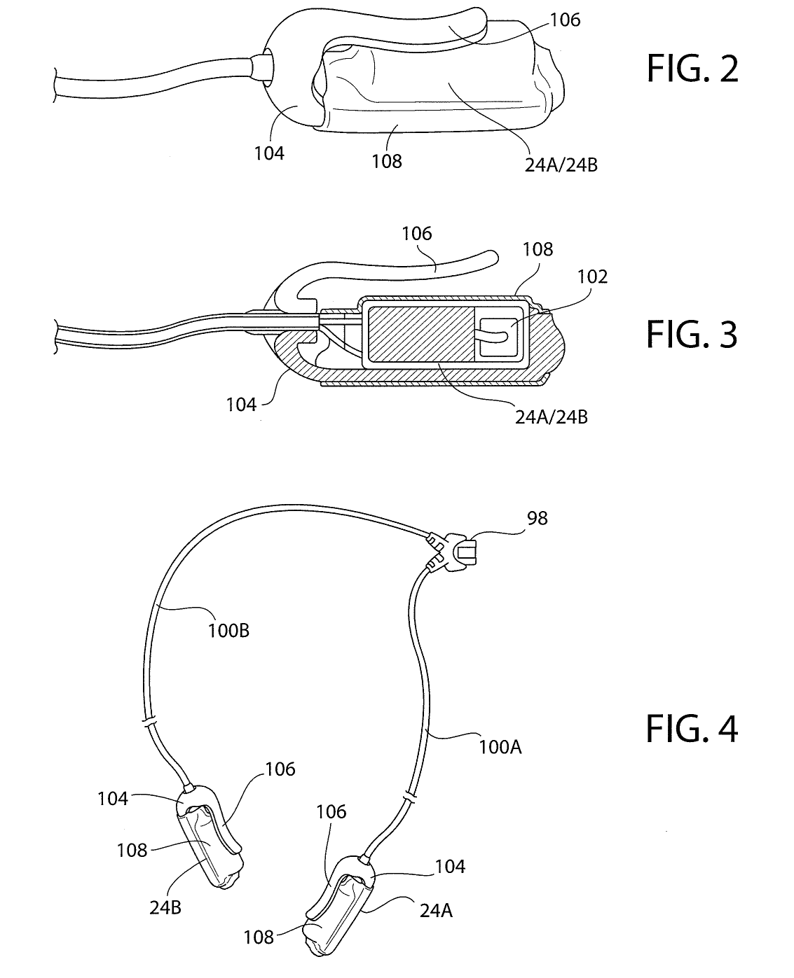

Turning now to FIGS. 2-4 the details of the construction of the motors 24A and 24B will now be described. Thus, as best seen in FIG. 3, each of the motors includes an eccentric weight 102, which when the motor is energized rotates about the rotational axis of the motor to vibrate the motor. Each motor is mounted in a motor holder 104 that includes a clip 106. The clip curves away from the motor holder on the leading edge, in order to enable the insertion of the band 22 between the clip and the motor holder, and is designed to allow for the motor holder to be rotated on the band up to 60 degrees in either direction for maximum comfort and effect of therapy. While the microprocessor's programming is the primary driver for establishing the desired random-like mechanical stimulation provided by the vibration motors, it has been found that changing the position with respect to gravity of some vibration motors, such as that proposed for the preferred embodiment, has a tendency to influence the vibration frequency and amplitude of the motors. Similarly, movement of the motors such as the act of walking, crossing the legs, tapping the foot, etc. and changes in pressure acting on the motors, such as from a tightening or loosening of the strap or muscles, have a tendency to influence or change the frequency and amplitude of the vibration output and thus enhance the randomness or apparent randomness of the vibrations produced. Moreover, it has been determined that varying the amplitude and/or frequency of the vibration in one motor also has the effect of inherently influencing in a non-predictable manner some variation in the other (due to the fact that the vibrations from one motor will be propagated to some degree to the other motor). This effect is particularly true when considered in conjunction with the effects of the physical environment in which the motors are operated (e.g., the effects of gravity, etc.).

Since some mechanoreceptors are more sensitive to frequency variations, while others are more sensitive to amplitude variations, the apparent randomness of the changing of the amplitude and/or frequency is believed to have a significant beneficial effect over a monotonic (uniform) vibration by reducing the effects of neural adaptation. Thus, the vibratory stimulation produced by the subject invention is particularly effective for treating RLS. Further still, the vibrations produced by the system 20 have a massage-like effect which is believed to enhance the natural release of dopamine and serotonin and decrease the release of cortisol.

Each motor holder 104 is formed of a relatively hard material, e.g., a plastic, and has a rounded leading end to further assist in the insertion of the band 22 between the clip and the motor housing. Moreover, it is devoid of sharp edges or corners to prevent the potential for injury and also to ensure the comfort of the user. The motor holder's shape is cylindrical to facilitate comfort when placed behind a heavily bent knee, as well as to be moved more easily, as it provides less surface area to be contacted by either the leg or the elastic band. Alternate shapes of the motor holder may include spiral, circular, triangular or square clips, among others. The shape may also be flattened and curved in different directions so it curves around the user's leg or arm and distributes the forces applied to the leg by the motor holder and leg band, etc. The motor holder may also be more fully rotatable up to a full 360 degrees in any direction. The motor is held in place in the motor holder by use of a heat shrink band 108. Any exposed connections in the back of the motors are protected by a few drops of UV glue (not shown) applied within the heat shrink tube and the motor holder and cured in place.

With this arrangement, the vibrations produced by each motor is propagated from the motor itself, through its associated housing to the portion of the user's skin in contact with the motor housing. The band or wrap 22 may also propagate some of the vibratory energy from the motor to the underlying skin and tissue.

Since the motor holders 104 are adjustable (e.g., they can be mounted on the band 22 at any longitudinal position and can be oriented as desired), the motors can be specifically targeted to tendons, ligaments, the fluidic capsules of the major joints (e.g., knee, ankle, etc.), to specific nerves or to any particular portion of the anatomy of the user to take advantage of the proprioceptors and mechanoreceptors located thereat and in adjacent anatomic structures.

The exemplary motors 24A and 24B are small, lightweight and are highly responsive, e.g., they come to a complete stop from maximum output within 20 milliseconds and start again to maximum output in 120 milliseconds, and have a very wide range of output intensity (peak acceleration of 0.1 m/s² to 49 m/s² in this application, within the limits of the chosen 3.7 V battery output range). Measurement of RMS acceleration, peak velocity and RMS velocity for one of the motors used in the system 20 was carried out using an accelerometer (whose weight was 45.9 gms) and a set-up of one motor (whose weight was 4.9 gms), positioned within a steel block (whose weight was 84 gms), so that the axis of rotation of the motor was perpendicular to the sensor of the accelerometer. The accelerometer was also attached to the steel block. The entire assembly was hung in mid-air to prevent influence on the readings from other masses, such as the table. Using that set-up the RMS acceleration maximum was determined to be 23.7 m/s², the RMS acceleration minimum was determined to be 0 m/s², the peak velocity maximum was determined to be 21.5 m/s, the peak velocity minimum was determined to be 0.8 m/s, the RMS velocity maximum was determined to be 15.0 m/s, and the RMS velocity minimum was determined to be 0.5 m/s. It should be noted at this juncture that the foregoing motor type is capable of producing even higher values for acceleration and velocity when attached to less weight.

It should also be noted that these motors are not all produced exactly alike. Small manufacturer defects and variances from motor to motor result in very slight differences in each motor's response to the programmed outputs of the control module, and other variables over time. As a result, even within the same motor and the same control module settings, with all other influences maintained unfalteringly, the motor output still takes on a somewhat random aspect in its actual running.

The motors and the manner in which they are mounted provides a system that is very quiet without diminishing vibration output, e.g., sound output levels in the range of 28 dB to 36 dB. According to the National Institutes of Health: National Institute on Deafness and Other Communications Disorders, the sound output level of normal breathing is about 10 dB, the rustling of leaves is about 20 dB, a whisper is about 30 dB, and a refrigerator hum or stream is about 40 dB, among other rankings.

Turning now to FIG. 10 the details of the electrical components making up the power and control module 26 will now be described. Those components are the heretofore identified battery 28, a battery charging circuit 110, a thermistor 112, a microprocessor or microcontroller 114, an associated memory 116, two pulse width modulators (PWMs) 118A and 118B, the heretofore identified buttons 30, 32, 34 and 36 and the heretofore identified LEDs 50, 52, 54, 56, 58, 60, 66, 68, 70, 72 and 74. The LED's make up what is denoted as the “LED display” in FIG. 10. The motors 24A and 24B are connected to the pulse width modulators 118A and 118B, respectively, and are arranged to produce the mechanical stimulation, e.g., vibrate, upon receipt of drive signals from the pulse width modulators. The pulse width modulators are connected to respective output terminals of the microcontroller and controlled by signals received from the microcontroller. The microcontroller provides those signals in response to inputs provided by the user-selected input buttons 30, 32, 34, and 36 in accordance with the programming of the microcontroller. The programming for the microcontroller resides in the microcontroller and in the memory 128. The microcontroller is also connected to the LED display to provide a visual display of the operating conditions of the apparatus 20, e.g., the mode selected, etc. Power for the microcontroller and the other electronics of the system shown in FIG. 1A is provided from the battery 28. The battery is rechargeable and is arranged to be charged by the charging circuit 110 via connection of the charger 38 to a conventional 110V receptacle.

The thermistor 124 is connected to the charging circuit and is physically located closely adjacent the battery to monitor its temperature. The thermistor is arranged to disable the charging circuit 110 in the event that the temperature of the battery 28 is above or below a desired temperature range (e.g., 0° C.-50° C.) in order to protect the battery from damage. Thus, if the thermistor reaches a temperature at or below 0° C., or at or above 50° C., the charging function is shut off. This protects the battery from damage, which may be hazardous to the user, and is performed separately from the software-based microcontroller (which controls the electrical signals provided to the motors to produce the desired mechanical stimulation). While the system is running, the battery supplies the software-based microcontroller with power.

As mentioned above, the programming for the microcontroller 114 is provided from an associated memory 116. That memory is preferably in the form of a separate microchip. The microcontroller and memory and other electrical components of the power and control module are disposed on a circuit board 120 (FIG. 1C) located within the housing 44. The microcontroller is operated by the software that is resident in the memory. This software instructs the microcontroller how to convert inputs from the user into outputs which produce the desired vibrations of the motors to provide the therapeutic benefits of the system 20. The inputs to the microcontroller are provided by the four buttons 30, 32, 34 and 36. In particular, the user inputs are derived from the pressing of one or more of those four buttons. Those buttons enable the user to turn the system on, to establish a one hour timer, to establish the intensity level of the stimulation (e.g., from “1” to “4”, with “4” being the highest or most intense), to select one of three user-selectable modes (e.g., Modes 1, 3 or 3) for the mechanical stimulation, and/or to provide continuous, or a five second pulse. Thus, when a button is pressed, the pressing of the button is communicated to the microcontroller, which converts the input into the appropriate output via the software. The buttons are part of the user interface of the apparatus. The user interface also includes the LEDs 50, 52, 54, 56, 58, 60, 66, 68, 70, 72 and 74. Thus, when a button is pressed to turn the system on, or to make a change to the intensity, mode, or pulse settings when the system is on, the microcontroller sends a signal to one or both of the pulse width modulators. The pulse width modulators control the motor outputs, especially with regard to fluctuations in voltage to the motors, which cause them to change amplitude, frequency and even turn on and off.

One significant feature of the power and control module is that it is constructed to prevent the battery from permanent damage, or ‘burning out’ as a result of over-discharging. Over-discharging Li-ion batteries can trigger the formation of copper shunts within the battery. These shunts may cause the battery to short-circuit, become unstable, overheat, etc. when recharging is attempted. To prevent this, the power and control module includes a protection circuit to shut the system off when the battery output is reduced to a previously specified voltage such as the recommended 2.75 V. As a result, this voltage remains in the battery, which maintains the battery chemistry and prevents the problems associated with over-discharge. This same protection circuit additionally protects the battery from over-charging, which also stresses the battery, and can lead to potentially hazardous outcomes.

As mentioned earlier, in order to protect the user from other battery-associated hazards such as electrical fire as a result of battery overheating, thermistor 112 is positioned near the battery in the housing. When the thermistor senses a certain threshold temperature, the system automatically shuts off until the temperature returns to an acceptable level. The shut-off mechanism is separate from the software-controlled microchip, thereby protecting the circuit even in the event of a software malfunction. In the preferred embodiment, the thermistor is set to shut the system off, or prevent charging and/or running of the system when the thermocouple senses a temperature of 50° C. or warmer, or when it senses temperatures of 0° C. or cooler. The cooler set-point further protects the battery from damage as the chosen battery should not be charged at cool temperatures ranging much below 0° C. Cooler temperatures increases charge resistance in batteries and in Li-ion batteries, such as that chosen for the preferred embodiment. More importantly, charging Li-ion batteries at cold temperatures causes metallic lithium plating to occur, which causes a permanent weakening of the battery, and increases the risk of battery failure with exposure to stresses such as vibration, heat exposure or dropping.

The following are exemplary components making up the electronic system. Battery 28 is a 14500 AA size rechargeable Li-ion cylindrical battery. The battery is an 800 mAh, 3.6V DC, type 14500 cylindrical Lithium-ion rechargeable cell, having external dimensions match that of a AA lead acid battery and is available from Tenergy of Fremont Calif. under model designation 30001-0. The estimated number of charge-discharge cycles is 500 cycles. The charger circuit is an in-circuit Li-ion charger, model MCP7387T-FCI/MF available from Microchip. The thermistor is a 10K ohm 30 mm long component available from Murata, PN NTSD1XH103FPB30. The microcontroller is available from Microchip under the model designation MCU 32 KB Flash 2 KB RAM 44 TQFP, PN PIC24F32KA304-I/PT). The buttons 30, 32, 34, and 36 are switch tactile top actuated 160GF surface mount components available from E-Switch, PN TL1015BF160QG. The display is made up of green clear 0603 surface mount LEDs available from LITE-ON, PN LTST-C190KGKT. The PWMs are MOSFET N-CH 28V 1.6A SC70-3-filtered with inductor power 68UH 0.62A SMD available from Bournes, PN SRR5028-680Y. The motors are vibration motors available from Jinlong Machinery of Brooklyn, New York under model designation Z7AL2B1692082.

As should be apparent from the foregoing the system 20 is modular in nature, e.g., the motors and/or control module can be removed from the band or wrap to facilitate cleaning of the band and the motors/control module, or for servicing/replacing any of the components should that become necessary. Moreover, the system is arranged so that there are two separate connectors for charging the battery and driving the motors. This enables the user to charge the battery without disconnecting the motors from the power and control module. The microprocessor is programmed so that the motors can be run while the battery is charging. To that end the power and control module detects the flow of current to the battery when the battery is being charged and in response to that detection the microprocessor prevents the operation of the pulse width modulators.

Since the power and control module is clip-mounted, that feature enables the placement of it at any position desired by the user in the interest of comfort and ease of use. Moreover, the orientation of the user interface controls, i.e., the indicia appearing next to the buttons and LEDs being upside down with regards to the ground, enables the user to readily read the indicia without having to take the wrap off his/her leg and turn it into the proper orientation to be read.

Use of the system 20 is as follows: The elastic loop band 22 is wrapped around the affected portion of the user's body, e.g., his/her leg, with the vibration motors 24A/24B preferably positioned directly over the target tendons or areas of joints. For instance, one motor could be placed directly over the patellar tendon or knee capsule and the other motor could be placed over the abaxial, or outer, hamstring tendon in back of the knee. Depending upon the construction of the system, the motors may be rotated on the elastic loop band for greater comfort or for a different feel. For instance, the motor over the hamstring tendon may be rotated so its length runs perpendicular to the long bones of the leg. The control module is placed on a free area of the elastic loop band 22 via the belt clip 46 on the back of the housing 44.

Once the mechanical stimulation assembly and control module are connected, power to the mechanical stimulation assembly may be applied by pressing the power button 30, one time from the off position for ‘On’ or twice from the off position for the one hour timer with auto shut-off. The intensity of the mechanical stimulation may be adjusted by pressing the second button one to four times until the desired intensity is achieved. The type of vibration is selected by pressing the third button until mode 1, 2, or 3 is selected. Finally, either continuous or pulsed vibration is selected by pressing the fourth button until either continuous (no pulse) or pulsed is selected.

The wrap may be worn until automatically shut off (timer), manually turned off, or until the battery output reaches the cut-off point, at which time, the charger or wall adapter should be plugged into the control module to facilitate re-charging of the battery. The charger or wall adapter should be connectable to a standard wall outlet for power. If the module still has power, it may be turned back on after being turned off, and may continue to supply power to the mechanical stimulation assembly until automatically or manually turned off, or until the battery output reaches the cut-off point.

As is known, movement of the legs tends to provide relief from RLS symptoms. From that fact, we hypothesize that stimulation of the proprioceptors, which occurs during walking or leg movement, is the mechanism via which RLS sensations are blocked. As is known, proprioceptors are located in the joints, muscle spindle afferents, and tendons. Mechanoreceptors are mostly located in the skin. Therefore, the highest concentration of receptors, which will most likely produce the greatest effect on RLS symptoms exist nearest joints, where all of the following receptors may be stimulated: mechanoreceptors in all layers of the skin covering the joint; proprioceptors located within the joint in the ligaments, which connect bone to bone; proprioceptors and mechanoreceptors located in the fluidic capsule; and proprioceptors located in the tendons, which connect bone to muscle, and which trigger the stimulation of nearby muscle spindle afferents when vibrated. Also, the greatest accuracy in proprioceptive activity is located near the joints. Therefore, one particularly efficacious use of the subject invention is to stimulate the proprioceptors in the leg by applying vibration to the tendons, which in turn should provide relief from RLS symptoms.

Analysis of the vibrations produced by the system 20 was carried out for the purposes of more fully describing its vibratory output. The discussion to follow includes various terms, whose definitions are as follows. FFT, or Fast Fourier Transform, is a term which used herein describes the result of an algorithm which decomposes a set of values, such as vibration output, into components of various frequencies Amplitude is a term as used herein to describe the y-axis values of the FFT reading, which are proportional to the acceleration of the motor, and are measured in volts. Main peak is a term as used herein to describe the single frequency with the highest amplitude per each set of data points. Significant peak is a term as used herein to describe frequencies, excluding the main peak frequency, which have amplitudes greater than or equal to 3% of the amplitude of the main peak.

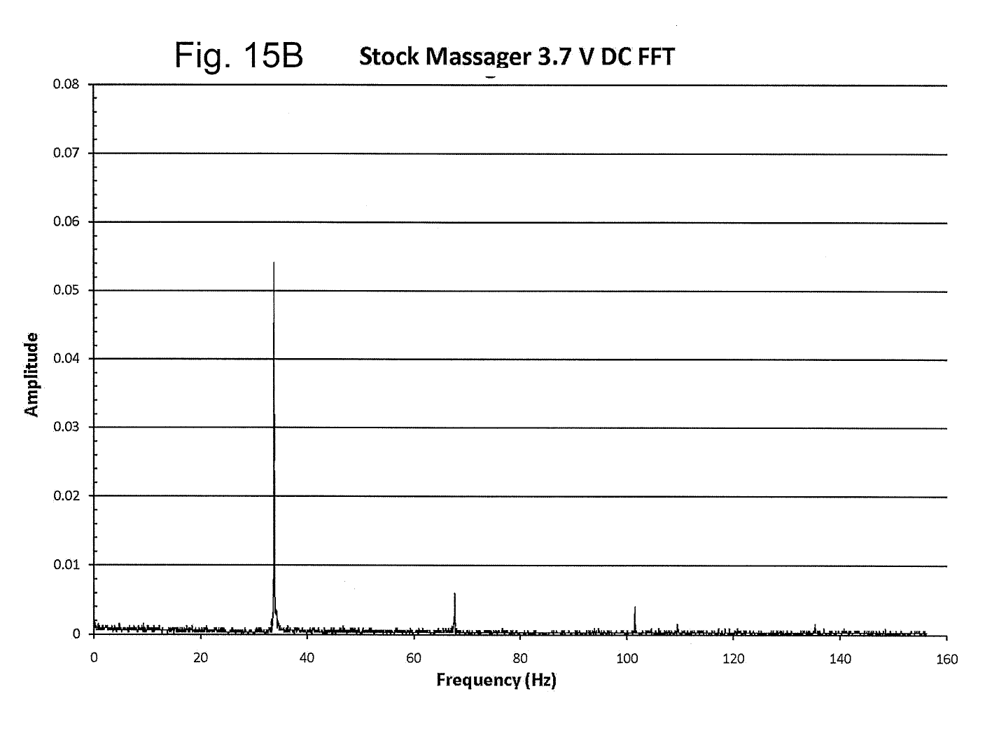

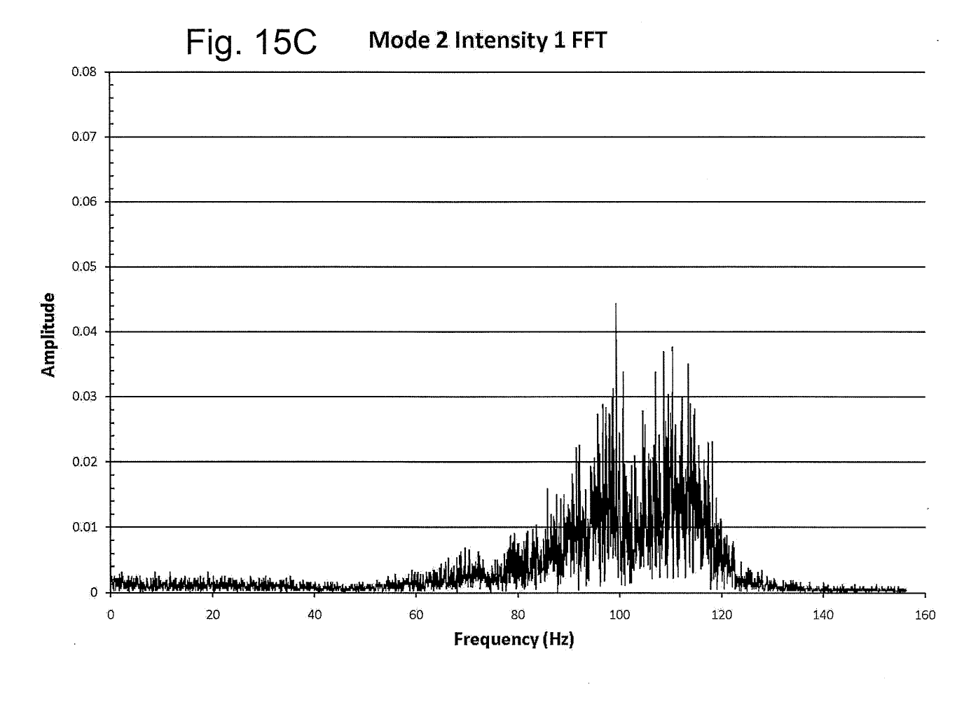

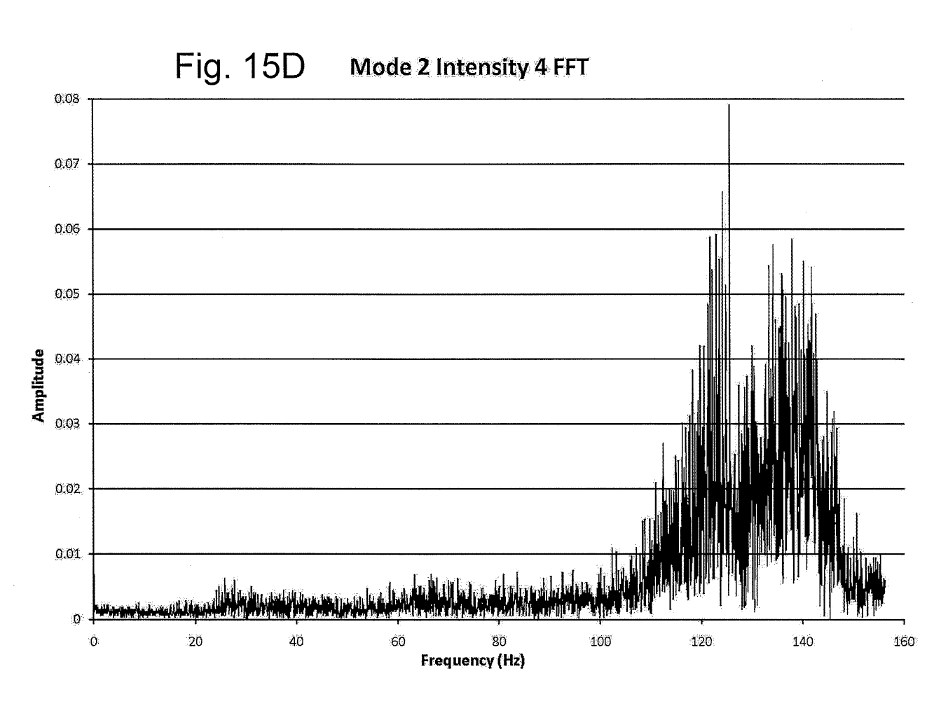

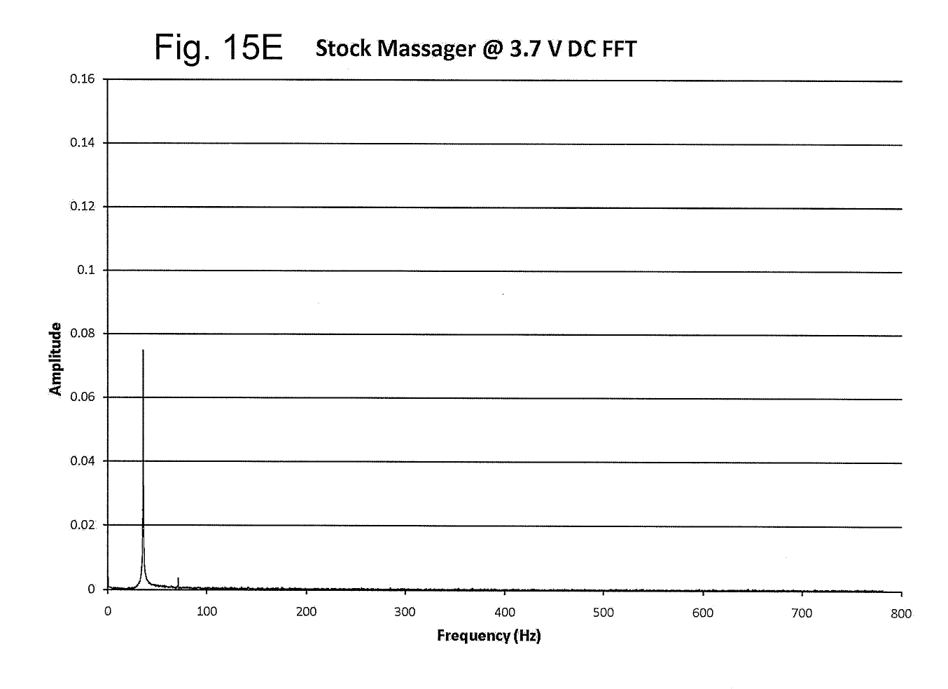

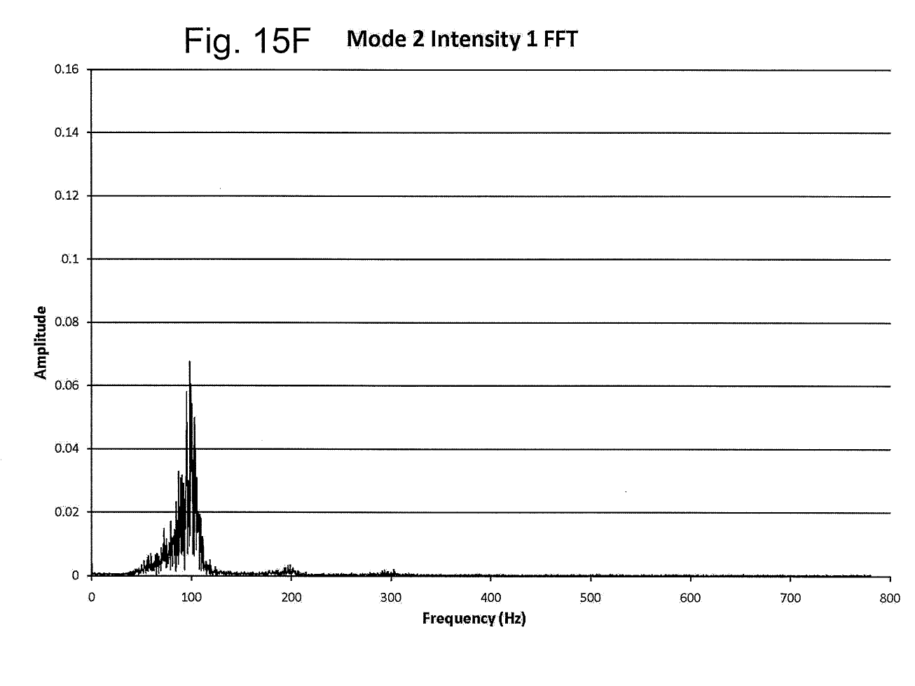

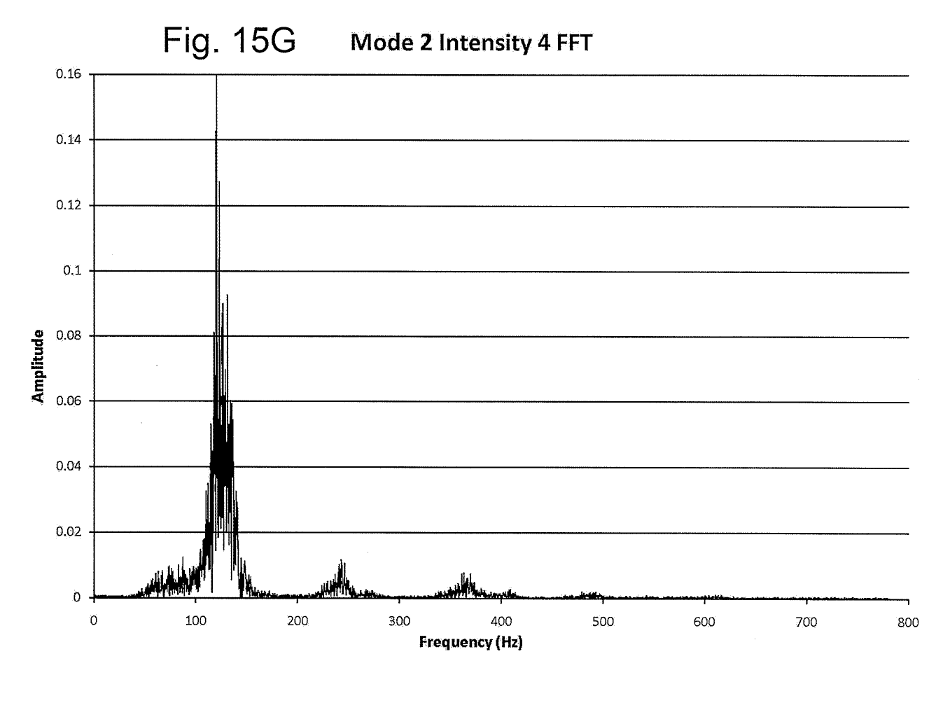

The system 20 outputs a measurable vibration signal which is applicable to the FFT algorithm. This signal, under various user selectable settings, is distinguishable from the vibration signals of other sources, such as stock (conventional, prior art) vibratory massage products and baseline, or background noise. Examples of vibration signals from these various sources have been graphed via the FFT algorithm. These graphs are as follows. FIG. 15A is a graph illustrating the Fast Fourier Transform (FFT) calculations of the baseline, or background noise vibration output produced when no system is connected to the sensor, as collected over 20 seconds. FIG. 15B is a similar graph of the vibration output of a stock (prior art) vibratory massage device as collected over 20 seconds. FIG. 15C is a similar graph of the vibration output of the system 20 set to Mode 2, Intensity 1 and no pulse as collected over 20 seconds. FIG. 15D is a similar graph of the vibration output of the system 20 set to Mode 2, Intensity 4 and no pulse as collected over 20 seconds. FIG. 15E is a similar graph of the vibration output of the stock vibratory massage device as collected over 4 seconds. FIG. 15F is a similar graph of the vibration output of the system 20 set to Mode 2, Intensity 1 and no pulse as collected over 4 seconds. FIG. 15G is a similar graph of the vibration output of the system 20 set to Mode 2, Intensity 4 and no pulse as collected over 4 seconds. The stock massager used as the control is a conventional consumer product, such as sold by Conair under the model designation NM8X.

The data making up the foregoing graphs was collected and the FFT calculation was accomplished using a Tektronik MSO 2012 oscilloscope. This device collects a maximum of 5,000 data points, which it maps at the same filter frequency regardless of the sample time. However, increasing the sample time, results in a shorter range of frequencies which are recorded. Thus, two sets of data were collected, each at a different sample times. These sample times were 4 seconds, and 20 seconds, and result in frequency ranges of collected data at 0-800 Hz, and 0-160 Hz, respectively.

Referring now to FIG. 15A it can be seen that the output is a wavering signal, which oscillates along a straight line between the amplitudes of 0 and 0.001, and lacks both main and significant peaks.

The graphs of FIGS. 15B and 15E illustrate the FFT calculations of the stock vibratory massage device as collected over 20 seconds and 4 seconds respectively, with these graphs representing frequency ranges of 0-160 Hz and 0-800 Hz, respectively. As can be seen the vibratory output displays a main peak of amplitude 0.055 (FIG. 15B) to 0.074 (FIG. 15E) at a frequency of 33 to 36 Hz. Further, two additional peaks are shown in FIG. 15B, at 67 Hz (amplitude of 0.006, also seen in FIG. 15E), and 102 Hz (amplitude of 0.004). These peaks likely represent harmonic frequencies of the main peak.

The graphs of FIGS. 15C and 15F illustrate the FFT calculations of the vibration output of system 20 with the data for these graphs collected across 20 seconds and 4 seconds, respectively, and represents frequency ranges of 0-160 Hz and 0-800 Hz, respectively. As can be seen, that output exhibits three distinct clusters of peaks. The first cluster ranges from 38 Hz (FIG. 15F) to 130 Hz (FIG. 15C), with a main peak amplitude ranging from 0.044 (FIG. 15C) to 0.067 (FIG. 15F) at 98 to 100 Hz. The second and third clusters of peaks exist in the frequency ranges of 165 to 228 Hz and 291 to 306 Hz respectively, with maximum amplitudes of 0.004 and 0.002.

The graphs of FIGS. 15D and 15G illustrate the FFT calculations of the vibration output of the system 20 with the data for these graphs collected across 20 seconds and 4 seconds, respectively, and represent frequency ranges of 0-160 Hz and 0-800 Hz, respectively. As can be seen from FIG. 15G the output exhibits three distinct clusters of peaks. The first cluster ranges in frequency from 0 Hz (FIG. 15D) to 160 Hz (FIG. 15G) with the main peak at a frequency of 120 Hz (FIG. 15G) to 126 Hz (FIG. 15D) and amplitude of 0.079 (FIG. 15D) to 0.162 (FIG. 15G). The second cluster ranges from 220 to 275 Hz with maximum amplitude of 0.012 at 243 Hz (graph 7). The 3^{rd} cluster ranges from 335 to 414 Hz with maximum amplitude of 0.008.

As should be appreciated from the foregoing, the system of this invention differs from the prior art (stock) massage device in that it produces a vibration signal, which when converted into components of various frequencies, produces a graphical display which includes a main peak and many significant peaks. Further, of these significant peaks, many are of 20% to 80% of the amplitude of the main peak. Others are smaller; but still are within 3% of the amplitude of the main peak. Finally, these significant and main peaks exist across a wide frequency range of 0-415 Hz, often these peaks lie across nearly every frequency value in separate frequency ranges such as 50-150 Hz, 200-300 Hz, and 320-400 Hz. Thus, the subject invention provides a stimulation signal (vibration) that when analyzed by Fast Fourier Transform includes a maximum peak and at least 1 (or 2, 5, 10, etc.) additional peak(s) that is (are) within 20% (or 30% or 40% or 50% up to 80%) of the amplitude of the maximum peak. Moreover, the at least three (or 5, 10, etc.) additional peaks are within 3% (up to 80%) of the amplitude of the maximum peak and those additional peaks include more than one (or 2, 5, 10, 20, etc.) significant peaks in a frequency range from 0-400 Hz (or 50-150 Hz, 0-60 Hz, 60-100 Hz, 100-200 Hz, 0-500 Hz, 100-200 Hz, 200-300 Hz, 300-400 Hz, etc.).

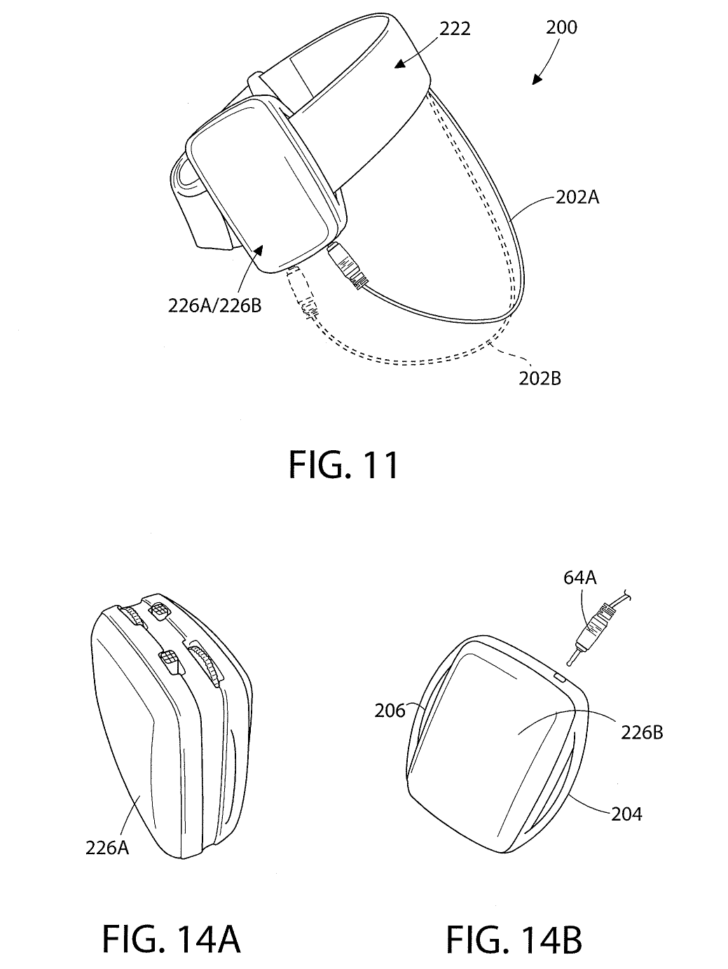

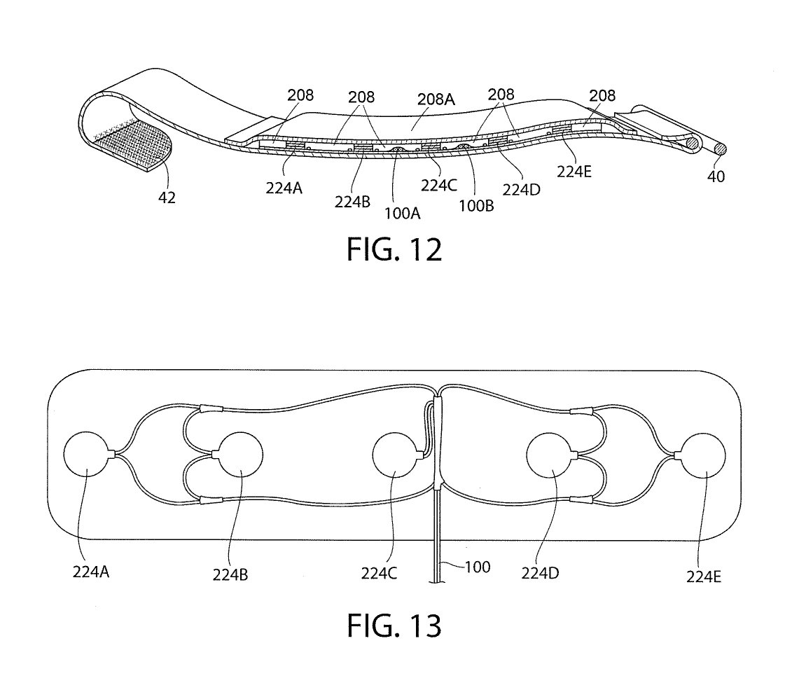

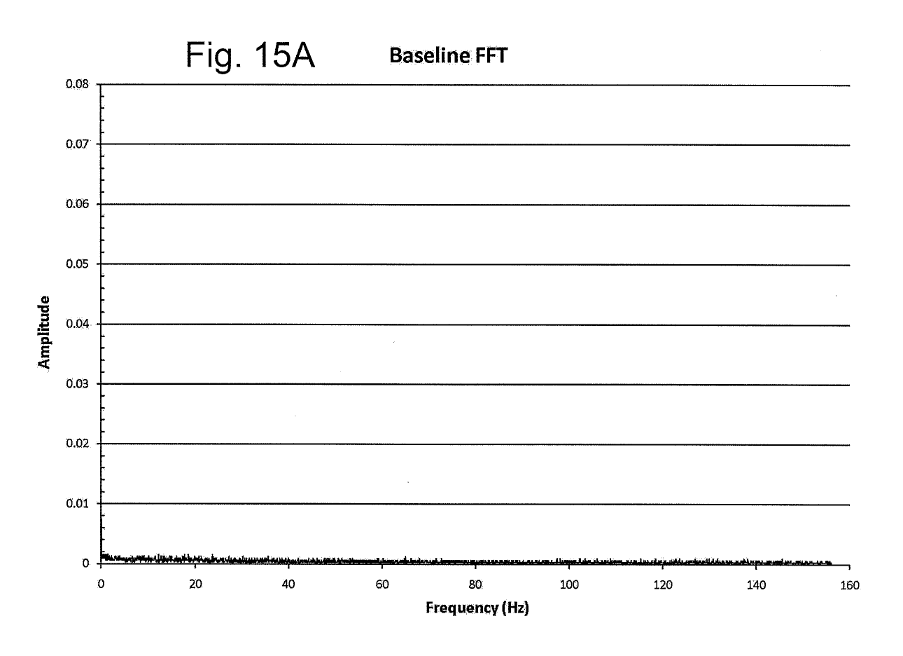

FIG. 11 shows another embodiment of a system 200 constructed in accordance with this invention for producing random-like vibrations. Moreover, like the system 20, the alternative system 200 includes a band or wrap 222 holding vibrating motors (to be described shortly) and a power and control module 226. In this embodiment five motors 224A, 224B, 224C, 224D and 224E (FIG. 13) are provided. The system 200 is somewhat less preferred than system 20 inasmuch as the five vibrating motors are physically located in a fixed position within the wrap or band 222, as best seen in FIGS. 12 and 13. The control for the motors is provided by a power and control module 226. In this exemplary embodiment the motors 224A-224E are coin-like vibrating motors. Each of those motors includes an eccentric weight, which when rotated, causes the motor to vibrate.

The control module 226 for variant system 200 can take various forms. For example, one form, shown in FIG. 14A, comprises a dual unit power and control module 226A, i.e., a unit comprising two circuit boards and associated user input controls. In that case one of the circuit boards is used to drive some of the motors, e.g., three of the five exemplary motors, while the other circuit board is used to drive the other of the motors, through respective cables 202A and 202B. The other form, shown in FIG. 14B, is a single unit power and control module, i.e., a unit comprising only a single circuit board for driving all of the motors via cable 202A. Thus, in FIG. 11 the cable 202B is shown in phantom to represent the fact that it is not used if the control module is of the single circuit board form. The control module 226A/226B includes user input controls similar to those of system 20, e.g., the intensity, mode, on/off, etc., and similar sockets or connectors for connecting the motor driving cables and for connecting to the charger as described above. As best seen in FIG. 14B, the housing for the power and control unit 226A/226B includes a pair of slots 204 and 206 through which the band or wrap 222 can be extended to hold the power and control unit in place at any longitudinal position along the band.

In FIG. 13 the physical layout of the five motors is shown for the single circuit board power and control module 226A. As can be seen, the motors are wired together in parallel via respective conductors, but are arranged so that three of the five motors rotate in opposite directions than the other two motors, to enhance the appearance of random-like vibrations.

In accordance with one exemplary embodiment of the system 200, the band 222 is somewhat different than band 22. In particular, band 222 comprises a first component, namely, an elastic band having loops on its outer surface (i.e., it is like band 22) and a second component (to be described shortly). The first component is available from Levitt Industrial Textile, under the trade designation Velstretch® 330, PN: 195520. It is also supplied by Textol Systems, Inc., PN: CM2X20KSTR. The ring 40 is available from Norman Shatz, PN: 102/12 1.5″. The tab 42 is available from Levitt Industrial Textile, PN: 189461, Other Code: 11/2BLHKPS.

The second component of the band 222 is a ⅛″ thick section of felt 208 (FIG. 12). The felt is available from McMaster-Carr, under model designation 8877K121. The motors are located within the felt. To that end, holes are punched in the felt and the motors are to tightly fit in those holes. The motors are coin-type, such as those available from Jinlong Machinery, under model designation C1034B018F. Channels are also cut to a depth in the felt to fit the wires connecting the motors to each other and to the rest of the power and control module components. The wires which exit the wrap connect to the control module and are wrapped once in staples or wire (not shown) to prevent the movement of the wires which might disconnect the circuit. The motors and wires are glued in place using quick-setting UV glue. This complete assembly is adhered to the elastic loop material of the band 22 by laying the adhesive backing of the felt face-down on the elastic band side of the elastic loop material. Another layer of felt 208A is adhered over the first layer of felt 208 to conceal and protect the motors.

With the use of a single component power/control module, only one wire may exit the wrap, in which case, all of the motors involved in the wrap may be wired together such that they spin all in the same direction, or in opposite directions. As mentioned earlier, half of the motors can be wired to one circuit board of a dual board power and control module while the other half of the motors are wired to the other circuit board. This enables each set of motors to be independently adjusted by the user as needed and allows the user greater control over the degree of randomness in the mechanical stimulation they experience. Again, the motors may be wired so they all spin the same direction or so they spin in opposing directions.

While the motors are connected in parallel to the power and control module, due to their construction the vibrations produced by each individual motor in response to a particular voltage applied to it varies from motor to motor. Thus, the application of any particular voltage to all of the motors will have the effect of each of the motors vibrating at a somewhat different frequency. The cumulative effect of the combination of those multiple vibration components will be vibrations simultaneously occurring at a broad range of frequencies so that the resulting vibrations fluctuate in amplitude. This action like that described with reference to system 20 is believed to have the beneficial effect of stimulating the various mechanoreceptors and pathways that are responsive to different frequencies. Moreover, the motors tend to drift somewhat in their output, so that the vibration produced by them changes over time. All of those effects tend to randomize the vibrations which are propagated from the system to the portion of the anatomy of the user at which the motors are located.

The exemplary motors 224A-224E are small pancake motors with brushes and eccentric weights, and are highly responsive. The manufacturer specifies that they are capable of an acceleration of 22 m/s² at 3V. Additionally, these motors are not all produced exactly alike. Small manufacturer defects and variances from motor to motor result in very slight differences in each motor's response to the programmed outputs of the control module, and other variables over time. As a result, even within the same motor and the same control module settings, with all other influences maintained unfalteringly, the motor output still takes on a somewhat random aspect in its actual running.

Other motors can also be used for this application, and may also exhibit similar randomizing qualities. Some of these motor types include, but are not limited to pancake motors, non-encapsulated motors, piezoelectric motors, motors with brushes, etc. Alternately, other forms of mechanical stimulation can be used for this application, such as local compression or tapping by such systems as pneumatic compression, pistons, rollers, wraps/bands, etc. or local skin-stretch or movement by rubbing or pulling or pushing on the skin in various directions.

The control module 226 is arranged to be placed on the band at any location with the band worn around the desired area. The band may be constructed to include a pocket in which the power and control module can be placed. Another alternative is that the module may be attached to a patch form of the device, along with the mechanical stimulation assembly.

The components of the system 200, like system 20, are modular. This modularity facilitates easy storage, transportation, repair, and cleaning.

The various components and arrangement disclosed above are not the only components/arrangements which can be used to form systems in accordance with this invention. To that end, the motors selected should exhibit one or more of the following features: quick to stop/highly responsive, wide range of output intensity, encapsulated (water resistance); small size (portability & comfortable to wear while sleeping) and eccentric weight.

Moreover, the use of the systems described above should not be construed as the only manner of using such systems. Thus, the subject invention can be used in various ways, other than those specifically described above. For example, therapy times can range from ten minutes to four or more hours, or until the battery dies. The therapy can be accomplished several times per day, at the same time and for the same duration regardless of symptoms, or can be used at different times and for different durations. It can be used daily, multiple times per week or multiple times per month when the symptoms start, when the symptoms persist or as a last resort. In fact, it can be used before symptoms start, but not necessarily at the same time each time.

The therapy can be applied to any area of the body that feels like the source of the undesired sensations, such as under the foot, on top of the foot, around the foot, around the ankle, around the calf at various locations along its length. It can be used around the knee, such as below it, behind it, on the medial side or on the lateral side. It can be used on or around the thigh at various locations along its length. It can be used on the lower back, on the shoulders, on the back of the neck, on the sides of the neck, on the forehead, on the back of the head, around the forearm at various positions along the length of the forearm, or around the upper arm at various positions along the length of the upper arm. To accomplish those ends the shape and size of the band or wrap will be selected for the particular anatomy involved. In fact it is contemplated that the two or more bands or wraps can be used in different places on the user, e.g., on the same leg, foot, arm, etc., or on different places on different legs, feet, arms, etc.

The bands or wraps can be applied and tightened to any degree between the brink of cutting off circulation to loose enough to slip off with slight movement and everything in between those two extremes. Moreover, while the descriptions of the systems and their uses set forth above have been in the context of wraps or bands, it should be clear that a system constructed in accordance with this invention need not be in the form of a wrap or band, so long as it can be applied to an area of the user's body where the mechanical stimulation is to be applied. Thus, the system can be constructed and arranged for use by merely being laid on top of the chosen area or can be constructed to be taped or otherwise releasably affixed to that area.

The systems and methods of this invention can be used by themselves or in combination with other treatments, e.g., in combination with Parkinson medications, anti-seizure medications, PLMD medications, anti-depression medications. Moreover, the subject apparatus and methods can be used with iron supplements or other vitamins and/or minerals. In fact, it is believe that the use of the subject invention when coupled with good heath habits, such as reductions in caffeine, alcohol, tobacco use, better eating and sleeping habits may result in enhance efficacy of the treatment. Treatment may also benefit from the user's movements, e.g., exercise and/or the application of heat.

As should be appreciated by those skilled in the art from the foregoing the subject invention provides mechanical vibratory energy, e.g., massage, which can temporarily relieve RLS symptoms. This is accomplished by the system topically applying mechanical stimulation to the affected area in a light weight, small, and low-risk manner. The system is highly portable to allow the user to comfortably wear it while sleeping, walking or otherwise engaging in normal activities which may result in movement. When the system makes use of an elastic wrap or band, the transmission of the mechanical stimulation is aided by the shape, flexibility, and elasticity of that wrap. It addition, it allows the user to apply, e.g., wrap the apparatus around the affected limb, over or near the affected area, and secure the device in a comfortable and stable manner to that area. Moreover, the wrap may comprise materials adapted to allow high transmittance of the mechanical stimulation throughout the wrap portion of the device, while maintaining a soft, pliable, non-irritating aspect, which prevents potential chafing, itching, or other adverse response from the user.

The subject invention counters the effect of neural adaptation and provides the ability to target mechanoreceptors in the free nerve endings in the skin and in afferent nerve fibers/proprioceptors in the tendons and ligaments. In addition, it stimulates Pacinian corpuscles and Ruffini corpuscles/free nerve endings in the capsule of the knee and stimulates free nerve endings of nearby muscle spindle afferents in the muscle tissue by vibration of tendons. To that end, the subject invention is arranged to target the full range of mechanoreceptors, e.g., frequencies of the patterns in tested vibratory counter stimulation sources range from <10 Hz to 1550 Hz depending on intensity, pressure, angle of motor with respect to gravity, and temperature of motor. The subject invention can effect the constant stimulation of multiple mechanoreceptors/nerve endings during each minute of therapy at a reduced noise level, without a reduction in its amplitude or intensity. In addition, several distinctly different counter stimulation patterns can be applied, as desired.

Owing to its modular construction the system of this invention enables a user to easily connect or disconnect the mechanical stimulation sources from the power and control unit and the power and control unit and/or the mechanical stimulation sources from the strap and from the charger/wall adapter. This enables a user to readily replace worn or broken parts, to clean (e.g., machine-wash the wrap and wipe down the counter stimulation sources and control unit with a cloth or paper towel dampened with cleaning fluid or water). In addition it facilitates transporting or packaging the apparatus. One can easily charge the battery while using the apparatus, with the apparatus partially dismantled (mechanical stimulation sources and/or strap disconnected from the control unit), or while the system is fully connected, but shut off.

Without further elaboration the foregoing will so fully illustrate our invention that others may, by applying current or future knowledge, adopt the same for use under various conditions of service.

We claim:

1. A system for applying therapeutic mechanical stimulation in the form of vibratory energy to a portion of the leg of a living being to provide relief for symptoms of restless leg syndrome, said system comprising a holding member and at least one mechanical stimulation producing device, said at least one mechanical stimulation producing device being held by said holding member, said holding member being arranged to be releasably secured to the portion of the body of the being to cause said at least one mechanical stimulation producing device to topically apply said mechanical stimulation to the leg of the being, said mechanical stimulation automatically varying in at least one of amplitude and frequency and appearing random-like or non-predictive to the being.

2. The system of claim 1 wherein said holding member comprises a flexible band.

3. The system of claim 1 wherein said mechanical stimulation varies in both amplitude and frequency.

4. The system of claim 2 wherein said at least one mechanical stimulation producing device comprises at least one vibrating motor.

5. The system of claim 4 wherein said system additionally comprises a power and control source to apply a voltage in a predetermined pattern to said at least one vibrating motor to cause said at least one vibrating motor to vibrate to produce said mechanical stimulation.

6. The system of claim 5 wherein the voltage applied to said at least one vibrating motor from said power and control source is adjustable to increase or decrease the intensity of said mechanical stimulation.

7. The system of claim 5 wherein said at least one vibrating motor is operated at a frequency in the range of 1 Hz to 500 Hz.

8. The system of claim 2 wherein said at least one mechanical stimulation producing device is arranged to be located at various positions along said band to be located closely adjacent a tendon or ligament in the leg of the being.

9. The system of claim 6 wherein said system provides at least two user selectable modes of operation, one of said user selectable modes comprises a soft mode, wherein said at least one of amplitude and frequency varies gradually and another of said at least two user selectable modes comprising a rough mode, wherein said at least one of amplitude and frequency varies more dramatically than said variations in said soft mode.

10. A system for applying therapeutic mechanical stimulation in the form of vibratory energy to a portion of the leg of a living being to provide relief for symptoms of restless leg syndrome, said system comprising a holding member and at least one mechanical stimulation producing device, said at least one mechanical stimulation producing device being held by said holding member, said holding member being arranged to be releasably secured to the portion of the body of the being to cause said at least one mechanical stimulation producing device to topically apply said mechanical stimulation to the portion of the body of the being, said mechanical stimulation automatically varying in at least one of amplitude and frequency at least one time per minute.

11. The system of claim 10 wherein said holding member comprises a flexible band.

12. The system of claim 10 wherein said mechanical stimulation varies in both amplitude and frequency.

13. The system of claim 11 wherein said at least one mechanical stimulation producing device comprises at least one vibrating motor.

14. The system of claim 13 wherein said system additionally comprises a power and control source to apply a voltage in a predetermined pattern to said at least one vibrating motor to cause said at least one vibrating motor to vibrate to produce said mechanical stimulation.

15. The system of claim 14 wherein the voltage applied to said at least one vibrating motor from said power and control source is adjustable to increase or decrease the intensity of said mechanical stimulation.

16. The system of claim 14 wherein said at least one vibrating motor is operated at a frequency in the range of 1 Hz to 500 Hz.

17. The system of claim 11 wherein said at least one mechanical stimulation producing device is arranged to be located at various positions along said band to be located closely adjacent a tendon or ligament in the leg of the being.

18. The system of claim 15 wherein said system provides at least two user selectable modes of operation, one of said user selectable modes comprises a soft mode, wherein said at least one of amplitude and frequency varies gradually and another of said at least two user selectable modes comprising a rough mode, wherein said at least one of amplitude and frequency varies more dramatically than said variations in said soft mode.

19. A method for applying therapeutic mechanical stimulation in the form of vibratory energy to the leg of a living being to provide relief from symptoms of restless leg syndrome, comprising:
topically applying said mechanical stimulation to the leg of the being closely adjacent a tendon or ligament to stimulate proprioceptors of the being; and
maintaining said mechanical stimulation for a sufficient period of time to result in some relief from the symptoms of restless leg syndrome.

20. The method of claim 19 wherein said mechanical stimulation is automatically varied in at least one of amplitude and frequency.

21. The method of claim 20 wherein said mechanical stimulation appear to random-like or non-predictive to the being.

22. The method of claim 20 wherein said variation in said at least one of amplitude and frequency occurs at least once per minute.

23. The method of claim 19 wherein said method is accomplished while the being is sleeping, walking, or otherwise engaging in activities which may result in movement of the portion of the body of the being.

24. The method of claim 19 wherein said mechanical stimulation is applied in plural user selectable modes.

25. The method of claim 24 wherein one of said user selectable mode comprises a soft mode, wherein said at least one of amplitude and frequency varies gradually and wherein another of said user selectable modes comprises a rough mode, wherein said at least one of amplitude and frequency varies more dramatically than said variations in said soft mode.
